(19) United States
(12) Patent Application Publication
(10) Pub. No.: US 2006/0072520 A1
(43) Pub. Date: Apr. 6, 2006

(54) Time synchronized standby state to the GPRS medium access control protocol with applications to mobile satellite systems

(76) Inventors: Prabhakar Rao Chitrapu, Blue Bell, PA (US); Robert Michael Stack, Douglassville, PA (US); Philip Talbot Farnum, Audubon, PA (US)

Correspondence Address: DUANE MORRIS LLP, PO BOX 5203, PRINCETON, NJ, 08543-5203, US

(21) Appl. No.: 09/814,788

(22) Filed: Mar. 22, 2001

Related U.S. Application Data
(60) Provisional application No. 60/191,552, filed on Mar. 23, 2000.

(51) Int. Cl. H04B 7/212

(52) U.S. Cl. 370/337

(57) ABSTRACT

Improved throughput is provided in a spacecraft TDMA cellular communications system by introducing a standby state, in addition to the idle and transfer states, of the medium access control (MAC) protocol, which controls the transfer of data over the radio interface between the network and the user terminals. The terrestrial locations include mobile user terminals and gateways which provide connections to the land line telephone system and/or the land packet data network i.e. Internet service provider. Each of the terrestrial terminals and gateways include a MAC to control the transmitting and receiving of data between the gateway and user terminals. Since packet data is bursty, multiple transitions occur between the idle and transfer states during data transfers. The new standby state maintains synchronization, reducing the transition time to the data transfer state by comparison with the transition time from an idle state where the network does not maintain user synchronization.

This application claims priority of provisional patent application Ser. No. 60/191,552 in the name of Chitrapu et al. filed Mar. 23, 2000.

### FIELD OF THE INVENTION

This invention relates to methods for transmitting data over spacecraft-based TDMA communication networks.

### BACKGROUND OF THE INVENTION

Mobile cellular communication systems have become of increasing importance, providing mobile users the security of being able to seek aid in case of trouble, allowing dispatching of delivery and other vehicles with little wasted time, providing users access to the Internet and the like. Present cellular communication systems use terrestrial transmitters, such as fixed sites or towers, to define each cell of the system, so that the extent of a particular cellular communication system is limited by the region over which the towers are distributed. Many parts of the world are relatively inaccessible, or, as in the case of the ocean, do not lend themselves to location of a plurality of dispersed cellular sites. In these regions of the world, spacecraft-based communication systems may be preferable to terrestrial-based systems. It is desirable that a spacecraft cellular communications system adhere, insofar as possible, to the standards which are common to terrestrial systems, and in particular to such systems as the GLOBAL SYSTEM FOR MOBILE COMMUNICATIONS system (GSM) including the General Packet Radio Service (GPRS).

The GSM system is a cellular communications system which communicates with user terminals by means of electromagnetic transmissions from, and receptions of such electromagnetic signals at, fixed sites or towers spaced across the countryside. The GSM system is described in detail in the text The GSM System for Mobile Communications, subtitled A Comprehensive Overview of the European Digital Cellular System, authored by Michel Mouly and Marie-Bernadette Pautet, and published in 1992 by the authors, at 4, rue Elisée Reclus, F-91120 Palaiseau, France. Another text that describes the GSM system is Mobile Radio Communications, by Raymond Steele, published by Pentech Press, London, ISBN 0-7273-1406-8. Each fixed site or tower (tower) of the GSM system includes transmitter and receiver arrangements, and communicates with user terminals by way of signals having a bandwidth of 50 Mhz., centered on 900 Mhz., and also by way of signals having a bandwidth of 150 Mhz., centered on 1800 Mhz.

The invention herein relates generally to cellular communications systems capable of handling both voice and data signals, and more particularly to such systems which provide coverage between terrestrial terminals in a region by way of a spacecraft, where some of the terrestrial terminals may be mobile terminals, and some may be gateways which link the voice services of the cellular system with a terrestrial network such as a public switched telephone network (PSTN) and links the data services to a packet data network such as an Internet service provider.

A salient feature of a spacecraft communication system is that all of the electromagnetic transmissions to the user terminals originate from one, or possibly a few, spacecraft. Consequently, the spacecraft communication antenna must form a plurality of beams, each of which is directed toward a different portion of the underlying target region, so as to divide the target area into cells. The cells defined by the beams will generally overlap, so that a user communication terminal may be located in one of the beams, or in the overlap region between two beams, in which case communication between the user communication terminal and the spacecraft is accomplished over one of the beams, generally that one of the beams which provides the greatest gain or signal power to the user terminal. Operation of spacecraft communication systems may be accomplished in many ways, among which is Time-Division Multiple Access, (TDMA), among which are those systems described, for example, in conjunction with U.S. Pat. No. 4,641,304, issued Feb. 3, 1987, and U.S. Pat. No. 4,688,213, issued Aug. 18, 1987, both in the name of Raychaudhuri. Spacecraft time-division multiple access communication systems are controlled by a controller which synchronizes the transmissions to account for propagation delay between the terrestrial terminals and the spacecraft, as is well known to those skilled in the art of time division multiple access systems. The control information, whether generated on the ground or at the spacecraft, is ultimately transmitted from the spacecraft to each of the user terminals. Consequently, some types of control signals must be transmitted continuously over each of the beams in order to reach all of the potential users of the system. More specifically, since a terrestrial terminal may begin operation at any random moment, the control signals must be present at all times in order to allow the terrestrial terminal to begin its transmissions or reception (come into time and control synchronism with the communication system) with the least delay.

When the spacecraft is providing cellular service over a large land mass, many cellular beams may be required. In one embodiment, the number of separate spot beams is one hundred and forty. As mentioned above, each beam carries control signals. These signals include frequency and time information, broadcast messages, paging messages, and the like. Some of these control signals, such as synchronization signals, are a prerequisite for any other reception, and so may be considered to be most important. When the user communication terminal is synchronized, it is capable of receiving other signals, such as paging signals.

FIG. 1 is a simplified block diagram of a spacecraft or satellite cellular communications system 10 as described in U.S. Pat. No. 5,974,314 issued Oct. 26, 1999 to Hudson. In system 10, a spacecraft 12 includes a transmitter (TX) arrangement 12t, a receiver (RX) arrangement 12r, and a frequency-dependent channelizer 12c, which routes bands of frequencies from the receiver 12r to the transmitter 12t. Spacecraft 12 also includes an array of frequency converters 12cv, which convert each uplink frequency to an appropriate downlink frequency. Antenna 12a generates a plurality 20 of spot beams, one or more spot beams for each frequency band. Some of the spot beams 20a, 20b, and 20c of set 20 are illustrated by their outlines, while other beams, such as 20d and 20e, are illustrated by “lightning bolt” symbols in order to simplify the drawing. Each spot beam 20x (where x represents any subscript) defines a footprint on the surface 1 of the earth below. The footprint associated with spot beam 20a is at the nadir 3 directly under the spacecraft, and is designated 20af. The footprint associated with spot beam 20c is designated 20cf, and is directed toward the horizon 5, while the footprint 20bf associated with spot beam 20b is on a location on surface 1 which lies between nadir 3 and horizon 5. It will be understood that those antenna beams which are illustrated in “lightning bolt” form also produce footprints. Those antenna beams illustrated by lightning bolts may be spot beams similar to the others, or they may be beams with broader footprints. As is known to those skilled in the art, the footprints of spot beams from a spacecraft may overlap (overlap not illustrated), to provide continuous coverage of the terrestrial region covered by the spot beams.

As illustrated in FIG. 1, a group 16 of mobile terrestrial user terminals or stations includes three user terminals, denominated 16a, 16b, and 16c, each of which is illustrated as having an upstanding whip antenna 17a, 17b, and 17c, respectively. User terminal 16a lies on or within the footprint 20af, user terminal 16b lies within footprint 20bf, and user terminal 16c lies within footprint 20cf. User terminals 16a, 16b, and 16c provide communications service to users, as described below. Those skilled in the art will recognize that the illustration of a single user terminal in each footprint is only for ease of understanding, and that many such user terminals may be found in each footprint. More particularly, each illustrated user terminal 16a represents one of a plurality of user terminals which may be found within footprint 20af, and likewise illustrated user terminals 16b and 16c each represent one of a plurality of user terminals which may be found in footprints 20bf and 20cf, respectively.

FIG. 1 also illustrates a terrestrial gateway terminal (a fixed site, tower, or station) 14, which lies in a footprint (not designated) of spot beam 20e. While not illustrated, it should be understood that the footprint associated with spot beam 20e may also contain user terminals such as 16ₓ. Gateway terminal 14 communicates with spacecraft 12 by way of electromagnetic signals transmitted from an antenna 14a, and receives signals from the spacecraft by way of the same antenna. Gateway terminal 14 is coupled by a data path 9 with a land-line network or public switched telephone system (PSTN) illustrated as a block 8, and provides communication between spacecraft cellular communications system 10 and the PSTN 8. While a single gateway 14 is illustrated, the system 10 may contain many gateways at spaced-apart locations, to allow the spacecraft communication system to access different PSTNs. The signals traversing antenna beam 20e represent information or traffic signals from the user terminals 16 to the gateway terminal 14, and information signals from the gateway to various ones of the user terminals. The information signals are designated generally as COMM.

A network control center (NCC) 18 is illustrated in FIG. 1 as a terrestrial terminal lying in a footprint (not designated) of antenna beam 20d, which may also contain user terminals (not illustrated). Network control center 18 includes an antenna 18a for communication with the spacecraft, and for communication by way of the spacecraft to the user terminals 16 and the gateway(s) 14. Network control center 18 also includes a GPS receiving antenna 18g for receiving global positioning time signals, to provide position information and an accurate time clock. Network control center 18 performs the synchronization and TDMA slot control which the spacecraft cellular communications network requires. The functions of network control center 18 may be distributed throughout the communication system 10, but unlike the arrangement of the GPS system, in which control of the slot timing is independently set at each cell center or tower, there is only one network control center associated with the spacecraft communication system 10, for the required control of the time-division multiple access slots cannot be applied simply to one cell or antenna beam, but rather must be applied across the entire system, for reasons which are made clear below. While network control center 18 is illustrated in FIG. 1 as being separate from gateway 14, those skilled in the art will recognize that the network control center 18 includes functions, such as the antenna 18a, which are duplicated in the gateway 14, and that it may make economic sense to place the network control center 18, or the portions which together make up the network control center, at the sites of the gateway(s) such as gateway 14, so as to reduce the overall system cost by taking advantage of the redundancies to eliminate expensive subsystems. The signals traversing antenna beam 20d between NCC 18 and spacecraft 12 represent control signals. “Forward” control signals proceed from the NCC 18 to the remainder of the communication system 10 by way of spacecraft 12, and “reverse” or “return” control signals are those which originate at terrestrial terminals other than the NCC, and which are sent to the NCC by way of the spacecraft. Forward control signals include, for example, commands from the NCC 18 to the various user terminals 16ₓ, indicating which TDMA slot set is to be used by each user terminal for communication, while an example of a return control signal may be, for example, requests by various user terminals 16ₓ for access to the communication system 10. Other control signals are required, some of which are described in more detail below. As mentioned, those control signals flowing from NCC 18 to other portions of the communication system 18 are termed “forward” control signals, while those flowing in a retrograde direction, from the communication system 10 toward the NCC, are denominated “return” control signals.

The spacecraft 12 of FIG. 1 may need to produce many spot beams 20, and the transmissions over the spot beams may require substantial electrical power, at least in part because of the relatively low gain of the simple antennas 17 of the user terminals 16. In order to reduce the power required by the transmitters in the spacecraft, the largest number of downlink frequencies, namely those used for transmissions from the spacecraft to terrestrial user terminals, are desirably within a relatively low frequency band, to take advantage of the increased component efficiencies at the lower frequencies. The user terminals transmit to the spacecraft at the lower frequencies, for like reasons. The transmissions to and from the spacecraft from the NCC 18 and the gateway(s) 14 may be within a higher frequency band, in part because of FCC frequency allocation considerations, and in part to obtain the advantage of high antenna gain available at the higher frequencies from large antennas at fixed installations. In a specific embodiment, the uplinks and downlinks of the NCC and the gateways may be at C-band (frequencies at about 3400 to 6700 MHz.), while the uplinks and downlinks of the user terminals are at L-band (frequencies at about 1500-1700 MHz). Thus, the uplink and downlink signals in antenna beams 20a, 20b, and 20c of FIG. 1 are at frequencies within the relatively low L-band, while the uplink and downlink signals in antenna beams 20d and 20e are at the higher C-band.

FIG. 2 is similar to FIG. 1, except that, instead of illustrating the antenna beams 20_{X} (where the subscript x represents any one of the antenna beams) as a whole, some of the individual carriers contained in the beams are illustrated separately. For example, some of the forward control signals flowing from network control center 18 to the spacecraft 12 over antenna beam 20d are designated 105, 109, and 113, while some of the return control signals flowing from the spacecraft 12 to the NCC 18 by way of antenna beam 20d are designated 106, 110, and 114. Each of these control signals is transmitted on a carrier of a different frequency, for reasons described below. Thus, the designations 105, 106, 109, 110, 113, and 114 in FIG. 2 may each be imagined to represent a different carrier frequency within C band. In practice, each of the forward control signals has a bandwidth of 200 KHz. As described below, each of the different uplinked control signal carriers will ultimately be routed to a different one of the antenna beams and its associated footprint; three footprints are illustrated in FIGS. 1 and 2, so three uplinked forward control signal carriers are illustrated, namely carriers 105, 109, and 113. Similarly, each of the different return control signal carriers 106, 110, 114 downlinked from spacecraft 12 is generated by a user terminal 16 in a different one of the footprints illustrated in FIGS. 1 and 2; three footprints are illustrated, so the downlink portion of antenna beam 20e includes the three carriers 106, 110, and 114.

As mentioned above in relation to the discussion of FIG. 1, the spacecraft 12 includes frequency-dependent channelizers 12c and frequency converters 12cv. The three forward control signals 105, 109, and 113 uplinked from NCC 18 of FIG. 2 to the spacecraft are received at antenna 12a of the spacecraft, and routed by way of the channelizers 12c of the spacecraft to an appropriate one of the frequency converters 12cv, where they are frequency converted. For example, uplinked forward control signal 105 of FIG. 2 arriving at the spacecraft over antenna beam 20d at C-band is converted from C-band to a frequency within L-band. In order to make it easy to track the flow of signals in FIG. 2, the L-band frequency corresponding to C-band frequency 105 is also designated 105. It is easy to keep the meaning of these identical designations in mind, by viewing them as identifying the control signals being transmitted; the forward control information on C-band uplink “frequency” 105 is retransmitted from the spacecraft, after frequency conversion to L-band, within antenna beam 20a, as downlink 105. Thus, the forward control signal information for all user terminals 16a lying within footprint 20af is uplinked from NCC 18 in C-band to the spacecraft over antenna beam 20d, and converted to L-band downlink frequency 105 at the spacecraft, and transmitted in the L-band form over antenna beam 20a for use by all user terminals 16a within footprint 20af. Similarly, uplinked control signal 109 arriving at the spacecraft over antenna beam 20d at C-band is converted from C-band to a frequency within L-band. In order to make it easy to track the flow of signals, the L-band frequency corresponding to C-band frequency 109 is also designated 109. The control information on C-band uplink “frequency” 109 is retransmitted from the spacecraft on L-band, within antenna beam 20b, as downlink 109. Thus, the forward control signal information for all user terminals 16b lying within footprint 20bf is uplinked from NCC 18 in C-band to the spacecraft over antenna beam 20d, and converted to an L-band downlink frequency 109 at the spacecraft, and transmitted in the L-band form over antenna beam 20b for use by all user terminals 16b within footprint 20bf. For completeness, control signals generated at NCC 18 for ultimate transmission to user terminals 16c in footprint 20cf is generated at C-band at a frequency 113 different from frequencies 105 and 109, and is uplinked from NCC 18 to spacecraft 12. The C-band control signal 113 received at spacecraft 12 is frequency-converted to a frequency, designated as 113, in L-band, and transmitted over antenna beam 20c for use by all user terminals 16c lying in footprint 20cf

It should be noted, in relation to the discussion of FIG. 2, that the fact that forward control signals are transmitted on the same carriers to a group of user terminals 16 lying in a particular footprint does not necessarily mean that all the user terminals within that footprint must operate simultaneously or in the same manner; instead, within each control signal carrier, a plurality of TDMA slots are available, and each set of slots is capable of being directed or assigned to a different one of the user terminals within the footprint being controlled, so that the user terminals are individually controllable. Of course, simultaneous reception of broadcast forward control signals by all user terminals within a footprint is possible, and all user terminals receive information signals “simultaneously,” in that they may all be receiving transmissions at the same “time” as measured on a gross scale, although each individual message is received in a different time slot allocation. It should also be noted that, while control signals have not been described as being transmitted over antenna beam 20e between spacecraft 12 and gateway 14, the gateway (and any other gateways throughout the system) also require such control signal transmission. In the event that the NCC and the gateway are co-located, the control signals flowing therebetween may be connected directly, rather than by being routed through the spacecraft.

When a user terminal 16_{X} (where the subscript x represents any one of the user terminals) of FIG. 2 is initially turned on by a user, the user terminal will not initially have an assigned slot. In order to advise the NCC 18 that the user terminal is active and wishes to be assigned a slot by which it may communicate, the user terminal must first synchronize to the forward control signals, and then transmit a reverse control signal to the NCC 18 by way of spacecraft 12, requesting access in the form of assignment of an information carrier time slot. Thus, in addition to the forward control signals flowing from NCC 18 to the user terminals 16ₓ, additional return control signals also flow from the user terminals to the NCC 18. These control signals originating from the user terminals lying within a particular footprint are modulated onto uplink carriers at L-band and transmitted to the spacecraft, where they are converted to frequencies lying in C-band for transmission to the NCC 18. More particularly, return control signals originating at user terminals 16a lying within footprint 20af are modulated onto an L-band uplink carrier frequency designated as 106 in FIG. 2. The return control signals are received by spacecraft antenna 12a in beam 20a, and routed by channelizer 12c to the appropriate frequency converter of converter array 12cv for conversion to C-band frequency 106. C-band frequency 106 is routed by way of transmitter 12t to antenna 12a, for transmission over antenna beam 20d to NCC 18. Similarly, return control signals originating at user terminals 16b lying within footprint 20bf are modulated onto an L-band uplink carrier frequency designated as 110 in FIG. 2. The return control signals are received by spacecraft antenna 12a in beam 20b, and routed by channelizer 12c to the appropriate frequency converter 12cv for conversion to C-band frequency 110. C-band frequency 110 is routed by way of transmitter 12t to antenna 12a, for transmission over antenna beam 20d to NCC 18. For completeness, return control signals from user terminals 16c in footprint 20cf are modulated onto an L-band uplink carrier frequency designated as 114, and are received by spacecraft antenna 12a in beam 20c, routed to the appropriate frequency converter 12cv, converted to C-band frequency 114, and transmitted over antenna beam 20d to NCC 18.

Thus, NCC 18 transmits a single forward control signal carrier to each downlink spot beam 20a, 20b, 20c, . . . on a carrier at a frequency which identifies the downlink spot beam to which the forward control signal is directed. NCC 18 receives return control signals from the various user terminals in footprints associated with the spot beams, and one return carrier is associated with each spot beam. In each spot beam, user terminals receive forward control signals over a carrier in an L-band downlink, and transmit return control signals over an L-band uplink. Spot beam 20a is associated with forward and return control signal carriers 105 and 106, respectively, spot beam 20b is associated with forward and return control signal carriers 109 and 110, respectively, and beam 20c is associated with forward and return control signal carriers 113 and 114, respectively.

Only the control signal carriers have been so far described in the arrangement of FIG. 2. The whole point of the communication system 10 is to communicate information signals among the users, so each antenna beam also carries signal carriers on which information signals are modulated or multiplexed by FDMA/TDMA, under control of the NCC 18. It should first be noted that NCC 18 of FIG. 2 does not need any information signal carriers (unless, of course, it is associated with a gateway terminal as described above). In general, information signals flow between gateways and user terminals. More particularly, signals from public switched telephone system 8 of FIG. 2 which arrive over data path 9 at gateway 14 must be transmitted to the designated user terminal or other gateway, which is likely to be served by an antenna beam other than beam 20d which serves gateway 14. Gateway 14 must communicate the desired recipient by way of a return control signal to NCC 18, and receive instructions as to which uplink carrier is to be modulated with the data from PSTN 8, so that the data carrier, when frequency-converted by the frequency converters 12cv in spacecraft 12, is routed to that one of the antenna beams which serves the desired recipient of the information. Thus, when information is to be communicated from gateway 14 to the remainder of communication system 10, it is transmitted on a selected one of a plurality of uplink carriers, where the plurality is equal to the number of spot beams to be served. In the simplified representation of FIG. 2, three spot beams 20a, 20b, and 20c are served in the system, so gateway 14 must produce information signal carriers at three separate C-band uplink frequencies. These three carrier frequencies are illustrated as 107, 111, and 115. The information signal is modulated onto the appropriate one of the carriers, for example onto carrier 107, and transmitted to the spacecraft 12. At the spacecraft, the C-band carrier 107 is converted to an L-band frequency carrier, also designated 107, which is downlinked over spot beam 20a to those user terminals (and gateways, if any) lying in footprint 20af. Similarly, information modulated at gateway 14 onto C-band uplink carrier 111, and transmitted to the spacecraft, is converted to L-band carrier 111, and downlinked over spot beam 20b to user terminals lying in footprint 20bf. For completeness, information modulated at gateway 14 onto C-band uplink carrier 115, and transmitted to the spacecraft, is converted to L-band carrier 115, and downlinked over spot beam 20c to user terminals lying in footprint 20cf. Within each footprint, the various user terminals select the information signals directed or addressed to them by selecting the particular time slot set assigned by NCC 18 for that particular communication.

Once a user terminal 16x of FIG. 2 which wishes to initiate service on the network is synchronized with the network, it transmits information on a spacecraft random access channel (S-RACH), which is part of the return control signal channel, by which control information is transmitted on an uplink such as 106 of FIG. 2. Since the particular user has not yet been assigned a slot set, the initial request for access is not scheduled by the NCC, but is transmitted within a slot, since time synchronization has already been achieved. The duration of the return control signal bursts generated by the user terminals must be short enough to fit within the NCC receiving slot interval, and should be sufficiently shorter than the slot interval to provide an appropriate guard interval. The durations of the transmitted return control signal bursts are predetermined at the time of manufacture of the user terminals, or set before use, to match the receive slot intervals of the system in which they are to be used.

The NCC may receive return control signal bursts from user terminals with a receive slot duration which depends upon, or is a function of, the location of the footprint of the beam in which the user terminal lies. FIGS. 3a, 3b, and 3c are time-lines which represent receive slot intervals by which the NCC 18 of FIGS. 1 and 2 receives return control signal bursts from user terminals lying in footprints 20af, 20bf, and 20cf, respectively, of FIG. 1. In FIG. 3a, the receive slots 310a, 310b, 310c, . . . , 310n are relatively short, just slightly longer than the duration of a typical return control signal burst 312, illustrated as being associated with receive slot 310a. The guard times are illustrated as 311a and 311b. The receive slot durations 310a, 310b, 310c, . . . , 310n are appropriate for reception of bursts 312 which do not have substantial variation in their receive times, such as those which are transmitted from footprint 20af, in which there is no significant difference of propagation delay between user terminals at either edge of the footprint; the guard time is used only for errors attributable to factors other than propagation delay differences. In FIG. 3c, the durations of receive slots 316a, 316b, 316c, . . . , 316n are longer than the durations of slots 310a, 310b, 310c, . . . , 310n, while the durations of the transmitted return control signal bursts 312 remain the same. The result, as illustrated in FIG. 3c, is that the combination of guard times 317a and 317b is larger than the combination of 311a and 311b. This increased guard time is appropriate for reception of burst transmissions from a footprint which lies near horizon 5, such as footprint 20cf of FIG. 1. The distances between antenna 12a and the right and left edges of footprint 20cf of FIG. 1 differ, and this difference represents a propagation time difference between the spacecraft 12 and user terminals located near the two edges of the footprint. By making the receive slot duration relatively large, the burst 312 can occur anywhere within the receive slot, and still be recognized. Thus, burst 312a associated with receive slot interval 316a lies near the beginning of the interval, whereby it may be surmised that the user terminal which transmitted burst 312a was located near that edge of footprint 20cf which lay closer to the spacecraft. Similarly, burst 312b of FIG. 3c, received within slot interval 316c, lies near its right edge, whereupon it will be realized that the location of the corresponding user terminal which transmitted burst 312b lay near the outermost extremity of footprint 20cf of FIG. 1. In FIG. 3b, the durations of receive slots 314a, 314b, 314c, . . . , 314n are longer than the durations of slots 310a, 310b, 310c, . . . , 310n, but shorter than the durations of receive slots 316a, 316b, 316c, . . . , 316n, while the durations of the transmitted return control signal bursts 312 remain the same. The result, as illustrated in FIG. 3b, is that the combination of guard times 315a and 315b is larger than the combination of 311a and 311b. This increased guard time is appropriate for reception of burst transmissions from a footprint which lies between nadir 3 and horizon 5, such as footprint 20bf of FIG. 1. The return control carrier time slots have durations which are the same (a standard duration) across the entire communication system 10. While there is no necessary requirement which establishes the time by which the return control slots of more distant footprints are increased, it has been found to be convenient to increase the time durations in increments equal to the duration of one standard time slot.

The setting by the NCC 18 of FIG. 1 of the control return slot duration in dependence upon the footprint location merely requires a knowledge of which return control signal carrier frequencies correspond to which antenna beams, and therefore the footprints. It is a simple matter to set the receive slot duration at the NCC in accordance with the frequency of the return control signal carrier. FIG. 4 is a simplified block-diagram representation of an NCC. In FIG. 4, NCC 18 includes a transmit-receive (T/R) module 410 which couples antenna 18a to the input port of a low-noise amplifier and block downconverter illustrated together as 412, and to the output port of an upconverter and power amplifier arrangement 430. Low-noise amplifier and block downconverter 412 converts the C-band return control signal carriers to an intermediate frequency, and couples the downconverted signals to a return control signal carrier frequency demultiplexer 414, separates the downconverted return control signal carriers, so that only one downconverted return signal carrier appears on each output signal port 416a-416n of demultiplexer 414. Since each different return control signal carrier is associated with a different one of the spacecraft antenna beams 20ₓ, the identity of the antenna beam footprint from which each of the return control signal carriers originates is established by a simple one-to-one memory. The return control signals are converted to baseband, if not already at baseband, by an array of receivers (RX) 418a-418n, where n equals the number of spot antenna beams. As mentioned, the number of spot antenna beams in one embodiment is one hundred and forty. The baseband return control signals at the outputs of receivers 418a-418n are applied by way of signal paths 419a-419n to a processor 420, in which they are decoded and interpreted with the aid of time signals originating from a global positioning signal receiver 422 coupled to GPS antenna 18g. It should be understood that each signal path 419a-419n is itself is preferably a multibit data path. The processor 420 autonomously generates the control signals for the communication system 10, in that the control of the various slot intervals and commands is accomplished at too high a speed for direct human intervention. However, high-level or overall functioning is controlled by an operator console illustrated as 424.

The processor 420 of FIG. 4 produces, as its output, sets of forward control signal commands at baseband, with each set of forward control signals on one signal path of an array of signal paths 425a-425n. Each set of forward control signals on one of signal paths 425a-425n is destined for one spot beam. The baseband forward control signal sets appearing on signal paths 425a-425n are applied to an array of transmitters (TX) 426a-426n, respectively, for modulation as necessary, and for upconversion to the uplink C-band frequency range. The output signal of each transmitter 426a-426n is a forward control signal destined for a particular one of the spot beams, at an uplink carrier frequency which, after passing through the remainder of the NCC 18 of FIG. 4, and through channelizers 12c and frequency converters 12cv of the spacecraft, is routed over the appropriate spot beam to the desired footprint. The signals from transmitters 426a-426n are applied to a forward control signal frequency multiplexer 428, which combines the various control signals into one signal path, and applies the forward control signals so combined to a block 430, representing upconversion to the C-band uplink frequency, and power amplification as needed. The C-band uplink frequency signal, with all of its forward control signals, is applied by way of TR arrangement 410 to antenna 18a for transmission to the spacecraft.

The processing performed in processor 420, to set the slot duration for receiving the return control signals, in accordance with which path 419a-419n the particular return control signal appears on, is a trivial task, and requires no further explanation. There will ordinarily be no reason for dynamic allocation of slot duration, so the return control signal slot duration associated with each input signal path can be simply stored in memory. If the frequencies of the control signal carriers allocated to the various spot beams should change, or if more spot beams should be added, or if a spot beam should be redirected from a location close to nadir to a location nearer to the horizon, the memory may be reprogrammed by the operator.

These forward control signals may include commands for utilizing resources. In relation to the access request signals, the computer informs the user terminal in which direction, and in what amount, of time adjustment, required to synchronize the user terminal to the network. It may also compare the user identity with a log to validate the user, read the telephone number to which a user wishes to be connected, and to determine to which of many gateway terminals the call should be assigned.

FIGS. 5a, 5b, and 5c illustrate the time assignment of the various forward control signals generated by the NCC 18 of FIG. 4 for one forward control carrier destined for one spot beam. As illustrated in FIGS. 5a, 5b, and 5c, one control multiframe (the i^{th} multiframe is illustrated) includes one-hundred and two control frames numbered 0 to 101. Each of the control frames includes eight slots, numbered 0 to 7. For example, the first control frame illustrated in FIG. 3a is numbered 0, and includes eight slots, numbered TN_0, TN_1, TN_2, TN_3, TN_4, TN_5, TN_6, and TN_7. Similarly, the second control frame illustrated in FIG. 3a is numbered 1, and includes eight slots, numbered TN_0, TN_1, TN_2, TN_3, TN_4, TN_5, TN_6, and TN_7. Each slot illustrated in FIGS. 5a, 5b, and 5c has a duration of 156.25 bit intervals.

Thus, the progress of time in the timeline of FIGS. 5a, 5b, and 5c is not simply from left to right in the conventional manner, for the timeline would be too long to illustrate conveniently. Instead, time progresses from TN_0 of control frame 0, and then downward in sequence through TN_1, TN_2, TN_3, TN_4, TN_5, TN_6, and TN_7 of control frame 0, and from slot TN_7 of control frame 0 upward to the first slot (slot TN_0) in control frame 1. From the time associated with time slot TN_0 of control frame 1, the time line flows downward in sequence through slots TN_1, TN_2, TN_3, TN_4, TN_5, TN_6, and TN_7 of control frame 1, and from slot TN_7 of control frame 1 upward to the first slot (slot TN_0) in control frame 2. From this explanation, it will be understood that the time recurrently flows from top to bottom, left to right, through the time line of FIGS. 5a, 5b, and 5c.

Four traffic multiframes are illustrated in FIG. 5a, arbitrarily designated 4k, 4k+1, 4k+2, and 4k+3. The arbitrary value is a time marker which identifies the interval within a long period of time, such as three hours, to prevent any gross synchronizing errors. Each traffic multiframe 4k, 4k+1, 4k+2, and 4k+3 has a duration of twenty-six traffic frames; since the duration of each traffic frame is equal to the duration of a control frame, the first traffic multiframe 4k has a duration of twenty-six control frames. It should be noted that these four traffic multiframes frames 4k, 4k+1, 4k+2, and 4k+3 do not exactly align with the i^{th} control multiframe, in that the combination of the four traffic multiframes 4k, 4k+1, 4k+2, and 4k+3 has a duration of one-hundred and four (104) control or traffic frames, while the i^{th} control multiframe has a duration of one-hundred and two (102) control/traffic frames. In effect, the four-traffic-multiframe set “drifts” by two control/traffic frames per control multiframe. The traffic frames have the same duration as the control frames, so the four traffic multiframes 4k, 4k+1, 4k+2, and 4k+3 are in effect associated with one-hundred and four (104) control frames, while the i^{th} control multiframe is associated with one-hundred and two (102) control frames.

In the i^{th} forward control signal multiframe of FIGS. 5a, 5b, and 5c, the first time slot TN_0 in control multiframe 0 is designated H, representing a high-margin synchronizing signal (H), which is required in order to allow the user terminal (16a, 16b, 16c of FIGS. 1 and 2) to acquire frequency and bit synchronization so as to identify a particular set of time slots of the control multiframe, for synchronizing to the control multiframe. Other high-margin control signals occur in the i^{th} forward control signal multiframe, as described below. Time slots TN_1, TN_2, and TN_3 of control frame 0 are not initially assigned, as represented by lower-left-to-upper-right hatching in those slots. Slot TN_4 of control frame 0 is enforced idle, as suggested by the opposite-direction hatching. Slot intervals TN_5, TN_6, and TN_7 of control frame 0 are unassigned. These unassigned TDMA slot intervals, and other unassigned slot intervals described below, may be assigned to other control signals, or to traffic use, if desired, at some later time. TDMA slot TN_0 of control frame 1 is assigned to a synchronization burst (S), for providing the traffic frame number information to the user terminal, while the remaining slot intervals TN_1-TN-3 and TN_5-TN_7 are unassigned, and TN_4 is mandatorily idle. The first TDMA slot TN_0 of control frames 2, 3, 4, and 5 are assigned for use by the broadcast channel (S-BCCH), which provides general-purpose network information which is broadcast to all user terminals within the footprint of the beam with which the time line of FIGS. 5a, 5b, and 5c is associated. The remaining TDMA slots of control frames 2, 3, 4, and 5 are unassigned, except for the TN_4 slot, which is assigned for use by a high power alerting channel (S-HPACH), for alerting user terminals of incoming calls. Time slots TN_0 of control frames 6, 7, 8, and 9 are assigned to the access grant channel (S-AGCH), for transmitting information relating to the granting of access to one user terminal; the granting of access requires assigning of a traffic carrier frequency, and of identifying the particular TDMA slot set of that carrier which is to be used. Similarly, time slot TN_0 of control frames 10, 11, 12, and 13 are also assigned to S-AGCH; many such transmissions may be necessary per unit time, because there may be many user terminals which request access during each second of time, and the grant of access must be at the same rate of many access grants per second. Thus, S-AGCH signals are assigned to the first TDMA slots intervals of control frames 14-29 (except control frame 22) of FIG. 5a, and to the first slot interval of all control frames 30-101 of FIGS. 5b and 5c except control frames 51, 60, and 62-64, which are mandatory idle, and control frames 61 and 81, which are assigned for use by high margin synchronization control signals H. Thus, high margin synchronization control signals H occur in the first TDMA slot at the beginning of each control multiframe (at control frame 0), and at control frames 22, 61, and 81. The separation or pulse timing between the first and second H signals of each control multiframe is 22 control frame intervals, the separation between the second and third H signals of each control multiframe is 39 control frame intervals, the separation between the third and fourth H signals of each control multiframe is 20 control frame intervals, and the separation between the last H signal of one multiframe and the first H of the next control multiframe is 21 control frame intervals. Thus, the temporal spacing between mutually adjacent H signals is 22, 39, 20, and 21 control frame intervals. These nonuniform intervals are provided to aid the user terminals in identifying the beginning of the control multiframe, for faster synchronizing to the system.

In the time line of FIGS. 5a, 5b, and 5c, the high power alerting channel S-HPACH is provided for during the TN_4 slot interval of all the control frames 0-101, except for those which are mandatorily idle, which are the TN_4 slot intervals of control frames 0, 1, 21, 22, 61, 81, and 101. The idle slot intervals are provided in the same control frame as the H burst so that the high-margin H burst does not occur in the same frame as the high-margin signal S-HPACH, to thereby tend to reduce the power loading, and makes it simple to perform the calculations, described below, required to achieve offsetting the time lines.

The high-margin synchronization channel signals H of FIGS. 5a, 5b, and 5c, which occur four times during each control signal multiframe interval, are high margin because they are transmitted at a higher power level than the signals of ordinary margin. This is readily accomplished by, for example, increasing the power produced by a transmitter of array 426a-426n of FIG. 4 during that time in which it transmits an H signal or other high-margin signal. Identification of a high-margin signal may be carried from the computer 420 to the individual transmitters 426a-426n on a dedicated data path of each of data paths 425a-425n, where a logic high on the dedicated data path for that transmitter, for example, indicates that the data being transmitted is a high-margin signal, and the power level should be raised. As those skilled in the art of transmitters know, it is a simple matter to increase the output power of an active stage by switching an attenuator out-of-line, or by incrementing the supply voltage, or both.

The peak output power of the spacecraft attributable to control signals is reduced from that which would occur if the high-margin signals were to occur synchronously. Keeping in mind that the time-line of FIGS. 5a, 5b, and 5c represents the time-line for one forward control channel out of one-hundred and forty channels (in one embodiment), it is undesirable that all of the high margin control signals occur simultaneously, because the simultaneous occurrence would require a peak power capability many times the average power capability. The weight and complexity required for such a high peak power capability is reduced by unsynchronizing the time lines of the various channels relative to each other. FIGS. 6a, 6b, and 6c illustrate how three forward control signal time-lines 608, 611, and 613 can be offset in time or unsynchronized in a manner which tends to prevent simultaneous occurrence of high-margin signals H. As illustrated in FIG. 6a, the time-lines 608, 611, and 613 include high-amplitude portions H spaced apart by lower-amplitude or lower-margin portions LM. Time-line 608 is delayed by an amount 610 from an arbitrary reference time. Similarly, the time-line 611 of FIG. 6b is delayed by a different amount 612 from the arbitrary reference time, in a manner which misaligns the H signals of FIGS. 6a and 6b in time. Similarly, the time line 613 of FIG. 6c, representing a third forward control signal channel, is delayed by a third amount 614, so that the high-margin signals H of the time line of FIG. 6c are misaligned in time relative to those of FIGS. 6a and 6b. In a similar manner, each of many time lines may be offset to misalign their H signals. Since one embodiment of the communication system has one-hundred and forty individual spot beams, it also has a like number of forward control channels. Thus, it is necessary to unsynchronize 140 different time lines similar to that of FIGS. 5a, 5b, and 5c. Referring once again to FIGS. 5a, 5b, and 5c, it will be noted that the minimum number of control frame intervals between successive H signals is 20 intervals. Since each of the control frame intervals has eight slots, a minimum of 160 slot intervals occurs between successive H intervals. This is more than the number of spot beams, so it is possible to unsynchronize the 140 time lines by mutually delaying them by increments of a slot interval. Thus, the time line of FIG. 6b is delayed by 2 slot intervals from the time line of FIG. 6a, so that their H intervals are separated in time by two slot intervals. Similarly, the time line of FIG. 6a is delayed by an integer number of time intervals, illustrated as two, relative to the time line of FIG. 6c. While both differences are by increments of two slot intervals, the increments may be in any number of slot intervals which provides the desired unsynchronization, and may be by fractions of a slot interval if the number of forward control signal channels is very large, and exceeds the number of slots in the frame. It should be noted that it is not necessary to eliminate every simultaneous occurrence of the high-margin signals, but instead it is sufficient to eliminate some or preferably most of the simultaneous occurrences.

Implementation of the offset of the synchronization in the described manner is a simple matter, readily accomplished in the computer or processor 420 of FIG. 4. No additional description is believed to be required in order for a person of ordinary skill in the processor arts to be able to set up the requisite timing relationships. A concomitant of the requirement for simultaneous control of the forward channel slot timing is that a single NCC 18 must perform all the controlling for the entire communication system 10, unlike the arrangement of GSM, in which each separate cell location can contain its own NCC, independent of the control at other cell locations.

It is very desirable to minimize the power required to be produced by the spacecraft power source 12s, 12p of FIG. 1. The reduced power requirements allows the spacecraft to operate with a smaller solar panel power system than would otherwise be required, which is very advantageous from the point of view of spacecraft propellant load, in that more attitude control and station keeping propellant can be carried, and the operational lifetime of the spacecraft may therefore be longer.

The low gain of the whip or portable antenna 17 of the user terminals 16 of FIG. 1 tends to require greater effective radiated power (ERP) from the spacecraft 12 to establish reception with a given signal-to-noise ratio than if a more elaborate antenna were available at the user terminal. The possibility that the user terminal may be located within a building or other structure which tends to attenuate signals transmitted from the spacecraft to the mobile user terminal imposes a requirement that the signals transmitted from the spacecraft have a power greater than the minimum which the mobile user terminal is capable of detecting when the user terminal is located outdoors and under optimal reception conditions. In order to minimize the power requirements imposed on the spacecraft, only a single multipurpose forward control signal, modulated onto a carrier, is transmitted from the spacecraft over each antenna beam. The concomitant of this limitation is that the mobile user terminals in each antenna beam can rely only on one control signal for achieving all their communication control functions.

At the time of inception of communication between a mobile user terminal and another terminal by way of the spacecraft, before synchronization is fully established, the terrestrial user terminal 16x of FIG. 1 must receive signals arriving at its location from the spacecraft, and scan the signals so received in order to determine which spot beams are available in its location, and to synchronize itself to the cellular communications system 10. In order make such determinations, the mobile user terminal must in the first instance be able to receive the control signal which is transmitted from the spacecraft over the particular antenna beam associated with the footprint in which the user terminal lies. As mentioned above, there is only one forward control signal associated with each beam, and it is imperative that the user terminal be able to receive at least those portions of the forward control signal required for initial synchronization. Among the signals which must be received are paging signals, which are transmitted by the spacecraft to alert the user of a terrestrial station. If the user (and his portable terminal) is within a building or in a location which attenuates electromagnetic signals, the paging signal may not be received. In order to alleviate this problem, it is desirable to transmit this paging signal, and other important control signals, with the maximum possible power. However, the total power required for the control signals must be minimized, especially since there is one control carrier per antenna beam, and there may be 140 or more antenna beams produced by each spacecraft 12. This power problem is solved by increasing the relative power of the “high margin” control signals, and correspondingly decreasing the relative power of standard margin control signals, so the average power of each control signal is within the desired limits, but the benefits of the high margin control signals are obtained. FIGS. 6a, 6b, and 6c are simplified amplitude-time plots of the amplitude or instantaneous radiated power of three such forward control carriers.

A specific implementation of the satellite system generally as described in conjunction with FIGS. 1, 2, 3a, 3b, 3c, 4, 5a, 5b, and 5c is the Asian Cellular Satellite (ACeS) System which started operation in September 2000 providing cellular services throughout southeast Asia.

The European Telecommunications Standards Institute (ETSI) has promulgated standards for the transmission of packet data by General Packet Radio Service (GPRS). These GPRS standards are predicated on the GSM cellular system. This standard provides standards for a technique for multiplexing packet data from multiple user terminals over a common physical air interface. The packet radio service will support the transmission of the Internet Protocol transport over the GSM Air Interface. Such a service would allow connection of a computer fitted with an internet browser to a wireless user terminal, and allow the user to connect to a remote internet service provider. These standards provide for packet control channels including Packet Broadcast Control Channels (PBCCH), PacketCommon Control Channels (PCCCH), Packet Data Transfer Channel (PDTCH), Packet Associated Control Channel (PACCH), and Packet Timing Control Channel (PTCCH). In the specifications, the Packet Data Channel includes any one the groupings
(a) PBCCH+PCCCH+PDTCH+PACCH+PTCCH;
(b) PCCCH+PDTCH+PACCH+PTCCH; or
(c) PDTCH+PACCH+PTTCH,
   as well as other groupings not relevant to the invention,
   where
   PCCCH includes Packet Paging Channel (PPCH)+Packet Random Access Channel (PRACH)+Packet Access Grant Channel (PAGCH).

Circuit switched data passes through a channel dedicated to the user, by contrast with packet switched data, in which a particular user shares access of the channel with other users. The voice services provided by GSM are circuit switched, and the overlay provided by GPRS is packet switched on the underlying circuit switched channel. In a packet switched GSM communications system overlaid with the GPRS standards for data transmission, in the absence of PBCCH control signals, the broadcast control signaling information can be obtained from the circuit switched channels which are normally used for voice in the GSM. Likewise, in the absence of PCCCH control signals, the user terminals use the circuit switched CCCH control channels. Packet radio service over GSM is described in the article “General Packet Radio Service in GSM” by Cai et al., published at pp 122-131 of IEEE Communications Magazine, October, 1997 and in “Concepts, Services, Protocols of the New GSM Phase 2+ General Packet Radio Service, by Brasche et al., published at pp 94-104 of IEEE Communications Magazine, August, 1997.

The GPRS standard defines a Medium Access Control (MAC) protocol which controls data flow across the physical packet data channels including the multiplexing of multiple users onto a given packet data channel. In general, the GPRS MAC operates in one of two states, namely the packet idle state and the packet transfer state. In the packet idle state, the user terminal monitors the relevant paging subchannels on the PCCH control channel, if such is present, and if not present, the user terminal monitors the relevant paging subchannels on the CCCH. In other words, the GPRS system causes the user terminal to remain synchronized with the packet common control channel in the packet idle state, and if this packet common control channel is not available, the normal circuit switched channels, enhanced for packet services, are monitored. In the packet transfer state, a packet data transfer channel is used for sending or receiving one or more packets of data.

The transition from the idle state to the transfer state in GPRSoccurs by the user terminal sending an access request message on the PRACH (or RACH if PCCCH is not present) to the network in order to initiate an uplink packet data transfer. The network then grants radio resources in the form of one or more packet data channels and the number of radio blocks, for packet data transfer from the user terminal to the network. The transition from the idle to the transfer state can also occur by (or result from) the network sending a paging message on the PPCH (or PCH if PCCCH is not present) to the user terminal in order to initiate a downlink packet data transfer, which is followed by the user terminal responding on the PRACH (or RACH). The network then grants radio resources for transferring the packet data from the network to the user terminal (UT). In both cases, the first message from the user terminal is an access request on the PRACH (or RACH) channel.

The use of PRACH (or RACH) channel in GPRS serves two purposes: 1) Being a ‘Random Access’ channel, it enables multiple user terminals to share the channel on a contention basis, 2) During the Idle State, which may last a very long period of time, the time & frequency synchronization between the UT and the Network may be coarse, in the sense that the differences between the reference time and reference frequency of the UT and the Network can be large compared to the values allowable for normal packet data transfer on a PDTCH. Thus PRACH (or RACH) is designed with a relatively large amount of ‘guard time’, so that timing differences will not cause interference to the other time multiplexed signals on the same carrier. The GPRS time slot is approximately 576 microseconds. The GPRS access burst provides approximately 252 microseconds of guard time while the GPRS normal burst provides approximately 30 microseconds of guard time. The additional guard time is at the expense of information content i.e. the guard time of the access burst is equivalent to 60 bits of information that the normal burst fully utilizes as packet data content. Similarly, the signals received on the PRACH (or RACH) channels is processed in a more complex manner, searching over a larger window of frequency and time deviation. Thus, typically, the PRACH (or RACH) channels require more complex processing than that applied to the normal bursts of the PDTCH or PACCH channels.

To maintain fine timing and frequency synchronization during long periods of data transfers, the GPRS standard provides an optional continuous timing advance procedure using the PTCCH channel to maintain synchronization between the user terminal and the network during the transfer state of packet data over the PDTCH. The continuous timing advance procedure maintains synchronization of up to 16 user terminals multiplexed on one PDTCH. The continuous timing procedure requires participating user terminals to send an access burst once every 1.92 seconds using the assigned timing advance slots on the uplink PTCCH channel. The network measures the timing offset and issues a timing advance message. The timing advance message includes a timing advance command for each of the terminals using the timing advance procedure, four times over the 1.92 second period on the downlink PTCCH channel.

FIGS. 7a, 7b, 7c, 7d, 7e, 7f, 7g, and 7h together constitute a mapping of uplink access bursts and downlink timing advance (TA) messages onto groups of eight 52-multiframes, as set forth in the abovementioned GPRS standards. More particularly, FIG. 7a is for 52-multiframe n, FIG. 7b is for 52-multiframe n+1, FIG. 7c is for 52-multiframe n+2, FIG. 7d is for 52-multiframe n+3, FIG. 7e is for 52-multiframe n+4, FIG. 7f is for 52-multiframe n+5, FIG. 7g is for 52-multiframe n+6, and FIG. 7h is for 52-multiframe n+7 . . . . Within each mapping or timing diagram of

FIGS. 7a, 7b, 7c, 7d, 7e, 7f, 7g, and 7h, radio blocks designated as B0 through B11 represent four time slots of data transfer between a user terminal and a gateway. Thus, each time slot is represented by three radio blocks. The last or rightmost time block of each multiframe temporally adjoins the first time block of the next multiframe. For example, the time block designated as “3” at the right of FIG. 7a immediately precedes time block B0 of FIG. 7b. Thus, the set of multiframes of FIGS. 7a through 7h can be looked on as a stack representing sequential portion of a continuous signal stream. Each radio block of the signal stream has a duration equal to four GSM time slots, although these time slots are not contiguous, so that the overall time required for transmission of a radio block extends over more than four GSM time slots. The radio blocks are grouped into sets of three by virtue of additional “separator” single-slot-duration time slots (sometimes referred to as “frames” in the GPRS specification) designated 0, 1, 2 and 3 in FIGS. 7a, 4, 5, 6, and 7 in FIGS. 7b, 8, 9, 10, and 11 in FIGS. 7c, 12, 13, 14, and 15 in FIGS. 7d, 16, 17, 18, and 19 in FIGS. 7e, 20, 21, 22, and 23 in FIGS. 7f, 24, 25, 26, and 27 in FIG. 7g, and 28, 29, 30, and 31 in FIG. 7h. In each mapping of FIGS. 7a through 7h, alternate odd-numbered ones of the numbered “separator” one-slot-duration time slots are not hatched, to indicate that the time slots are not assigned to any specific use, and are designated “idle” in the specification. Even-numbered ones of the separator slots or frames are hatched to indicate that they are used for timing advance information or signals. Thus, the 0th and 2nd ones of the separator slots or frames of FIG. 7a are hatched, to indicate that they are used to carry timing advance information. Other even-numbered ones of the separator slots of FIGS. 7b through 7h are likewise hatched to indicate timing advance use.

Within each multiframe of FIGS. 7a, 7b, 7c, 7d, 7e, 7f, 7g, and 7h, the even-numbered or hatched slots of time are used for timing advance (TA) information. In the uplink direction, which is to say from the user terminal to the gateway, the 0th TA slot is used for timing advance index 0 information or messages, the 2nd slot is used for timing advance index 1, the fourth slot is used for timing advance index 2, the sixth slot is used for timing advance index 3, the eighth slot is used for timing advance index 4, the tenth slot is used for timing advance index 5, the twelfth slot is used for timing advance index 6, the fourteenth slot is used for timing advance index 7, the sixteenth slot is used for timing advance index 8, the eighteenth slot is used for timing advance index 9, the twentieth slot is used for timing advance index 10, the twenty-second slot is used for timing advance index 11, the twenty-fourth slot is used for timing advance index 12, the twenty-sixth slot is used for timing advance index 13, the twenty-eighth slot is used for timing advance index 14, and the thirtieth slot is used for timing advance index 15. In the downlink direction, which is to say from the gateway to the user terminal, the same time slots are used for timing advance messages. One complete timing advance message requires four sequential ones of the timing advance slots. However, each set of four timing advance slots includes timing advance information for a plurality of user terminals. As set forth by the GPRS standard, the plurality is sixteen. Thus, slots 0, 2, 4, and 6 of FIGS. 7a and 7b together contain the information relating to one timing advance message for each of sixteen user terminals. In the uplink direction, each user terminal sends an access burst during its assigned timing advance time slot. Thus, in FIG. 7a, that one of the sixteen user terminals assigned to TAI slot “0” transmits an access burst during TAI slot 0, that one of the sixteen user terminals assigned to TAI slot “1” transmits an access burst during TAI slot 1, and in FIG. 7b, those of the sixteen users assigned to time slots 2 and 3 transmit their access bursts during those two time intervals, respectively.

In the downlink direction of FIGS. 7a through 7h, the various gateways to which the user terminals are assigned transmit their timing advance information, each to its “own” user terminals. Each group of four timing advance slots in the downlink direction can be viewed as a four-slot “radio” block distributed in time. Each group of four timing advance slots, as for example slots designated 0, 2, 4, and 6 of FIGS. 7a AND 7b, carries timing advance information relating to sixteen of the user terminals. Each user terminal of the group of sixteen user terminals receives a timing advance signal every two multiframes. However, it takes eight multiframes, namely the multiframes of FIGS. 7a, 7b, 7c, 7d, 7e, and 7h, to transmit a single access burst from each of the sixteen user terminals. Consequently, each user terminal nominally receives four timing advance signals in the same time that it transmits one access burst. Only one of these four timing advance signals is needed in order for the timing to be corrected, so there is much more timing advance information available to each user terminal than is actually needed to correct the timing of the access burst. Thus, considerable information can be lost without losing control of the timing advance function or, correspondingly, loss of synchronization between the user terminal and the base station.

The GPRS standards cannot be applied directly to a spacecraft-based cellular communication system. One reason is that the timing uncertainty between a user terminal and a gateway, due to the vastly larger area covered by a spacecraft “spot” beam by comparison with that of a GSM cell. This large difference in coverage area means that there can be a large timing difference, relative to the duration of a time slot, between the propagation delay between two user terminals within the same spot beam, depending upon where in the spot beam the user terminals lie. By contrast, in a GSM cell, the corresponding time differences are small with respect to a time slot duration. The relatively large time differences between the various user terminals in a spot beam means that the access bursts transmitted by a user terminal can vary over several time slots, depending upon the location of that user terminal within the spot beam. Thus, the timing differences in a terrestrial system are small relative to the length of a slot period, but the same is not true for a satellite system.

In a Mobile Satellite System the timing deviations can be as large as several milliseconds, which is large compared to the time slot period of approximately 576 microseconds for a GSM system, depending upon the location of the UT in a spotbeam. Consequently, the PRACH (or RACH) channel for a Mobile Satellite System requires modification or a method must be developed for maintaining synchronization during the idle state.

Improved spacecraft cellular communications systems are desired.

### SUMMARY OF THE INVENTION

A method according to an aspect of the invention is for operating a user terminal of a wireless TDMA data communication system, where the communication system includes a network communication center and a plurality of gateways. The method comprises the step, at the user terminal, of operating in an idle state in which the user terminal is attached to a network so that the network is aware of the presence of the user terminal, but the user terminal is not in communication with a gateway. At the user terminal, a transition is made from the idle state to an active state in response to one of (a) the network and (b) the user terminal generating a signal indicating that data is to be transmitted. The transition is effected by use of common control channels of the data communication system, by transferring control to one of the gateways. In the active state, data is transferred between the user terminal and the gateway. Immediately following the transferring of the data, a transition is made from the active state to a standby state, in which timing information, but not data, is exchanged between the user terminal and the gateway. In response to generation of a further signal indicating that data is to be transmitted by (a) the user terminal and (b) the gateway, a transition is made from the standby state of operation to the active state of operation. Finally, in response to expiration of a preset period of time in which no signal indicating that data is to be transmitted is generated, a transition is made from the third standby state to the first idle state.

### BRIEF DESCRIPTION OF THE DRAWING

FIG. 1 is a simplified diagram of a spacecraft cellular communications system, illustrating some antenna beams which define system cells, and the extent of footprints of antenna beams directed at the nadir and at the horizon;

FIG. 2 is a simplified diagram similar to FIG. 1, illustrating some of the signals which flow over the various antenna beams;

FIGS. 3a, 3b, and 3c are simplified time lines illustrating the durations of the return control signal TDMA receive slots, which depend upon the location of the footprint of the spot beam at locations close to nadir, between nadir and horizon, and near the horizon, respectively;

FIG. 4 is a simplified block diagram of a network control center for generating return control signal receive slots;

FIGS. 5a, 5b, and 5c together constitute a timeline illustrating the mapping of the forward control signals in the i^{th} control multiframe;

FIGS. 6a, 6b, and 6c illustrate three time-offset time lines;

FIGS. 7a, 7b, 7c, 7d, 7e, 7f, 7g, and 7h together constitute a timeline of one complete cycle of the GPRS continuous timing advance procedure;

FIG. 8 is similar to FIG. 2 with the addition of an interface between the Gateway and a Packet Data Network to indicate the addition of packet data service to satellite system according to an aspect of the invention

FIG. 9 is a timeline of a message sequence for a GPRS enhanced satellite-based cellular system for packet data channel setup initiated by the user terminal in the idle state;

FIG. 10 is the state diagram for the improved MAC procedure which incorporates the standby state;

FIG. 11 is a timeline of the message sequence for a GPRS enhanced satellite-based cellular system for packet data channel setup initiated by the user terminal in the standby state;

FIGS. 12a, 12b, 12c, 12d, 12e, 12f, 12g, and 12h together constitute a timeline of one complete cycle of the standby PTCCH continuous timing advance procedure; and

FIG. 13 illustrates the Standby Access Burst requirements for both the standby-PRACH and the standby-PTCCH channels; and

FIG. 14 illustrates the Standby Timing Advance Index information element for use in channel assignment messages, using the PACCH channels, to assign the standby timing advance index value to the user terminal prior to entry into the standby state.

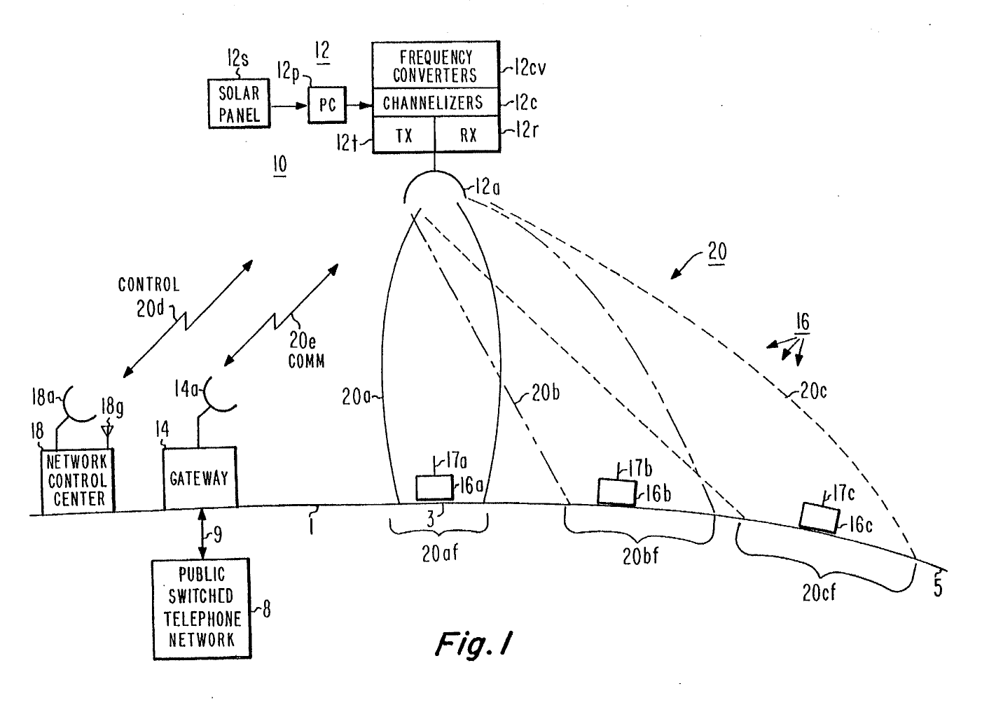

### DESCRIPTION OF THE INVENTION

The abovedescribed GPRS standard can be applied to a spacecraft-based cellular system such as ACeS.

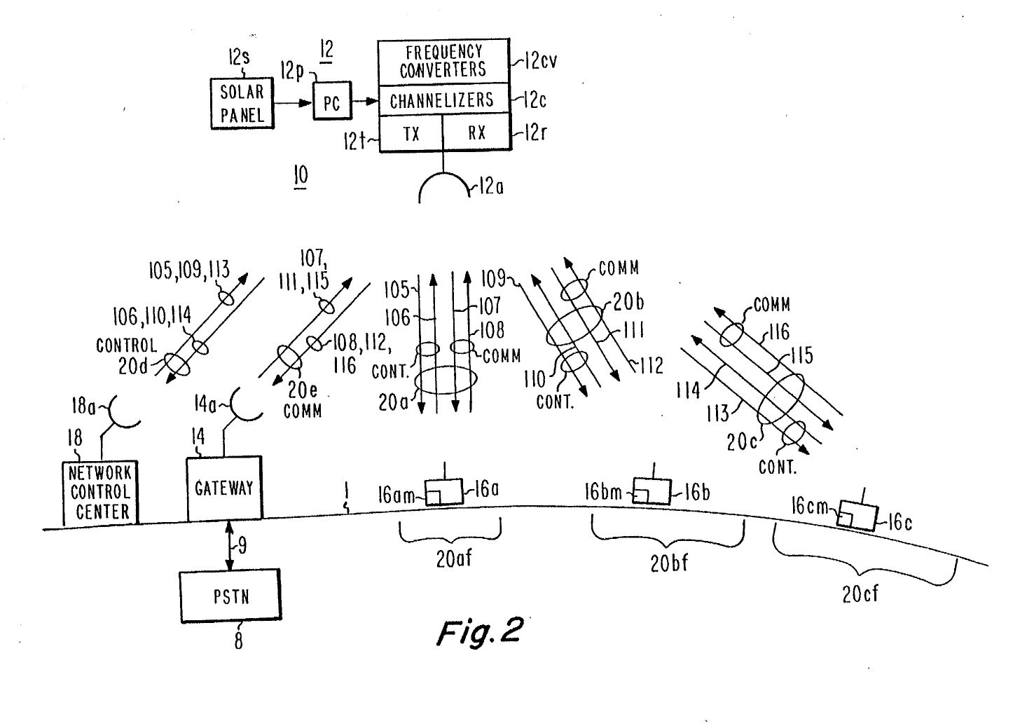

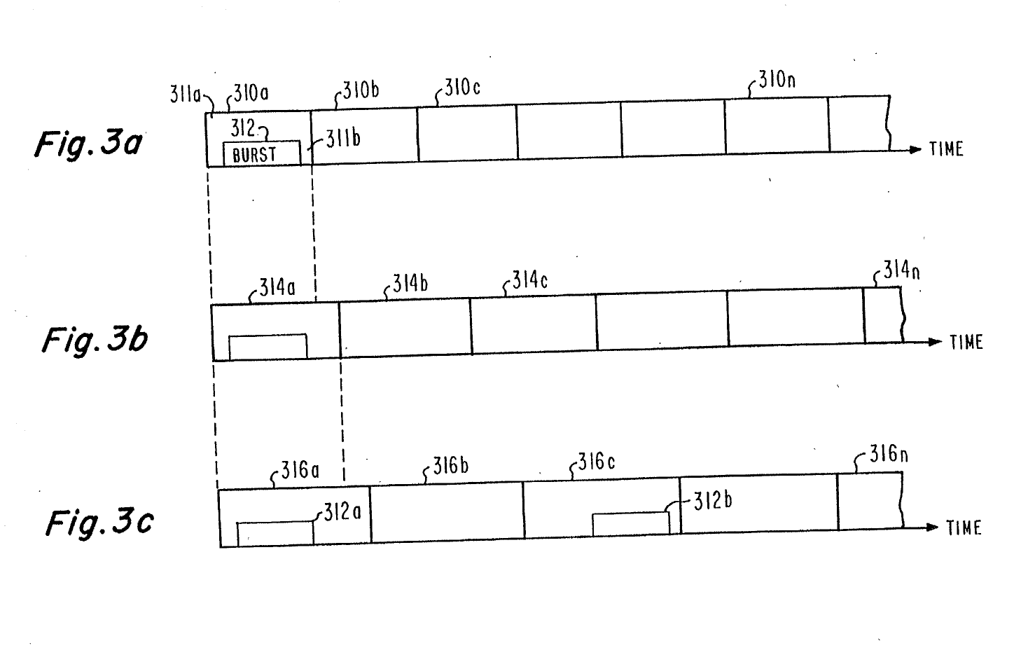

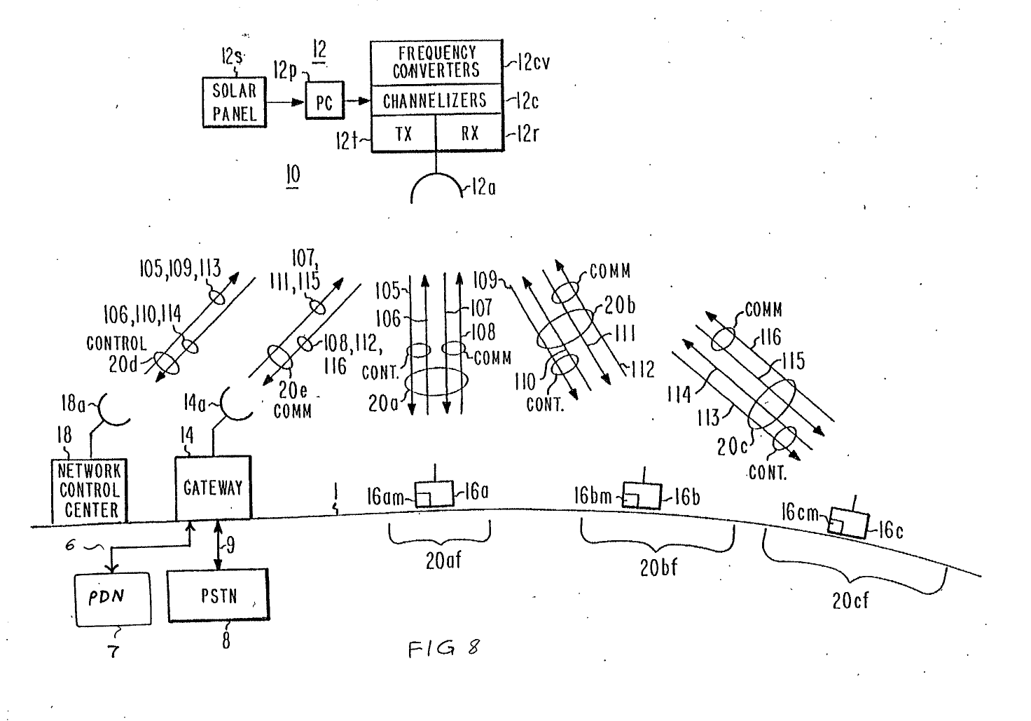

FIG. 8 represents the same spacecraft-based cellular system illustrated in FIG. 2 with enhancements to provide the GPRS standard. FIG. 8 adds a packet data network (PDN) 7 to provide access to packet data services such as connection to an internet service provider, connection to a corporation's intranet, and the like. To provide the packet data services, the network control center, the gateway and the user terminals are enhanced to add the GPRS functionality. The satellite does not require any enhancements. As defined in the GPRS standards, the user terminals can be data-only terminals, voice-only terminals, or combined voice- and data-terminals. The Network Control Center continues to provide the S-HBCCH, S-HMSCH, S-BCCH, S-HPACH, S-AGCH, and S-RACH control channels as described above. The control channels are enhanced with packet data information to support the packet data services.

The packet data network 7 provides a connection 6 to the satellite system's gateway 14. The gateway is enhanced to provide packet data services of GPRS. The gateway includes packet data functions and packet data channels for transferring packet data between the user terminal and the PDN. The gateway provides two different configurations of packet channels. For transferring data, the gateway provides one or more packet data channels, like those defined in the GPRS standards, consisting of packet data transfer channel (PDTCH), packet associated control channel (PACCH), and packet timing control channel (PTCCH). As an aspect of the invention, a new type of packet data channel is introduced, referred to herein as the standby data packet channel, to support the new MAC standby state, described below, which consist of standby packet common control channel (Standby-PCCCH), packet data transfer channel (PDTCH), packet associated control channel (PACCH), packet data transfer channel (PDTCH), packet timing control channel (PTCCH), and standby packet timing control channel (standby-PTCCH). The standby-PCCCH sub-channels consist of packet paging channel (PPCH), packet access grant channel (PAGCH), and standby packet random access channel (standby-PRACH). The standby-PRACH and standby-PTCCH form a part of this aspect of the invention and are described below. The gateway must provide at least one standby packet data channel to each spot beam where data packet service is to be supported. It should be noted that packet data transfers can be multiplexed on the standby packet data channel using the PDTCH, PACCH and PTCCH channels that coexist. Therefore, a gateway can offer packet data services to a given spot beam by providing a standby packet data channel which utilizes one TN of the carrier frequency dedicated to that spot beam as described above in conjunction with FIG. 2. The network control center provides knowledge of the standby packet data channel within a spot beam, if packet data services are offered within the spotbeam by a gateway, by enhancing the existing broadcast control channel information to include packet related control information including standby PCCCH information such as its frequency and time slot. A user terminal, in the idle state, listens to the S-BCCH and S-CCCH channels from the network control center. The user terminal stores the relevant packet control information, in particular the information on the standby packet data channel provided within the current spot beam, to be applied at such time that data transfers are activated. The user terminal continues to listen to, and remains synchronized to, the control channels from the network control center, until the network control center assigns dedicated channels as described above for voice services and as described below for packet data services. The gateway can allocate additional packet data channels, consisting of PDTCH, PACCH, and PTCCH, as demand for additional packet data capacity increases within a given spot beam.

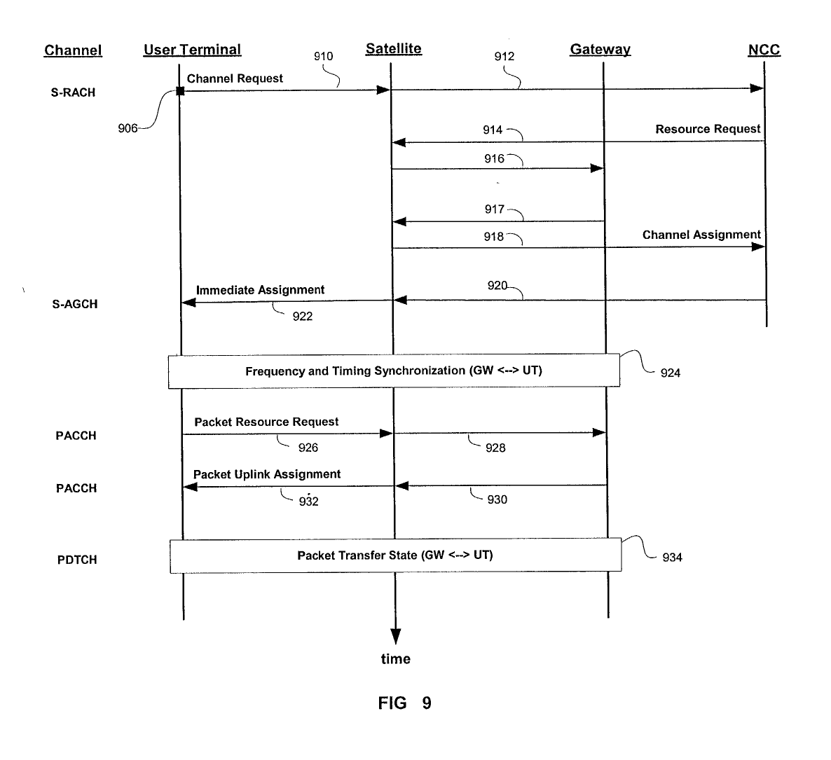

FIG. 9 represents the command timing sequence which might be used to apply the abovedescribed GPRS standard to a spacecraft-based cellular system such as ACeS. In FIG. 9, the user terminal, satellite, gateway and network control center (NCC) are illustrated by vertical lines, and time flows in a downward direction. In order to initiate a communication, a user terminal makes a channel request over a random access (S-RACH) channel, as represented by arrow 910. This channel request could be for voice, but this is not of interest; FIG. 9 relates only to requests for a packet channel for transmission of data. The satellite transmits the signal to the NCC, as represented by arrow 912. The NCC measures the timing offset of the user terminal with respect to the reference time as described in the prior art. The NCC sends a resource request which also includes the offset time of the user terminal, by way of the satellite, to the selected gateway, as illustrated by arrows 914 and 916. The selected gateway processes the request, and assigns frequency and time slot radio resources, if available, for use by that user terminal. The timing offset value is included in the assignment message as a timing advance command to the user terminal to aid time synchronization when user terminal makes connection with gateway on assigned packet data channel. The assignment message is transmitted, by way of the spacecraft (arrow 917) and on to the NCC by way of arrow 918. The NCC then relays the immediate assignment message to the spacecraft by way of arrow 920, and the spacecraft then relays the signal to the user terminal by way of arrow 922. At the time represented by the left end of arrow 922, the user terminal knows what radio blocks of what channel of what frequency may be used to contact the desired gateway. The user terminal also knows the timing advance value to apply to its transmissions. Now the gateway and the user terminal must achieve frequency synchronization. Synchronization information (frequency and some timing) must be exchanged between the user terminal and the gateway before actual data can be exchanged, which is represented in FIG. 9 by a rectangular block of time 924 encompassing the gateway, satellite and user terminal.

Once the synchronization represented by block 924 of FIG. 9 has been accomplished, a packet resource request is made by way of the PACCH channel, and transmitted by way of arrow 926 to the spacecraft. The spacecraft, in turn, sends the packet resource request to the gateway by way of arrow 928. The gateway can then assign resources to the requested packet data transmission. In particular, the gateway may reassign the slot or frequency (the packet data channel). The gateway then sends the packet uplink assignment information by way of the PACCH channel and arrows 930, 932 back to the user terminal. Following the receipt of the uplink assignment information, the user terminal and gateway interact in accordance with the applicable standards to transfer the data, as represented by block 934. The above describes the sequence for the user terminal, which is in the GPRS idle state, to initiate the setup of a packet data channel for uplinking data from the user terminal to the gateway. The corresponding network initiated setup of a packet data channel for downlinking data from the gateway to the user terminal has a similar sequence. The gateway sends a page message to the satellite which sends the message to the NCC. The NCC will include the page message in the S-HPACH channel and transmit the signal to the satellite which forwards the signal to the user terminal. If the user terminal is in the idle state, then the user terminal will be monitoring the S-HPACH channel for pages addressing the user terminal. The user terminal responds to the page request by sending a S-RACH to the NCC via the satellite. The remainder of the sequence is the same as described above for an uplink packet transfer with the exception that the gateway issues a packet downlink assignment message on the PACCH channel.

Data transmissions such as those used for the internet tend to be very bursty. In other words, the data arrives in packets separated by time. It is not practical, from an economic point of view, to maintain the packet channel open in the absence of transmissions, because of the value of such channels. The GPRS standards provide for termination of the packet transfer state in the absence of data transmissions, or at the completion of transfer of an identified block of data.

In the case of a spacecraft-based communication system, there is about one-eighth second one-way trip delay for transmissions to and from the satellite. Referring to FIG. 9, it will be noted that the channel setup includes twelve one-way propagations to and from the satellite, namely 910, 912, 914, 916, 917, 918, 920, 922, 926, 928, 932, and 930, corresponding to about one and one half second which is used solely for propagation delays, and not including any processing and synchronization delays. Thus, each initial setup of the data packet channel requires at least one and one-half second.

According to an aspect of the invention, an additional Medium Access Control (MAC) operating state is defined for spacecraft operations over those using the GPRS standards. This additional operating state is a “standby” state, in which the user terminal and the gateway are not transferring data, but in which frequency and timing synchronization is maintained. The system enters the standby state when the packet transfer state is terminated, and remains in the standby state for a predetermined period of time. In a preferred embodiment of this aspect of the invention this time delay is configurable. This state of operation prevents the system from deconfiguring the data packet channel upon the occurrence of a momentary termination of data transfer, which might be for as little as a few milliseconds, and reduces the subsequent delay by as much as a one half second or more to reconfigure the data packet channel in response to the receipt of the next packet.

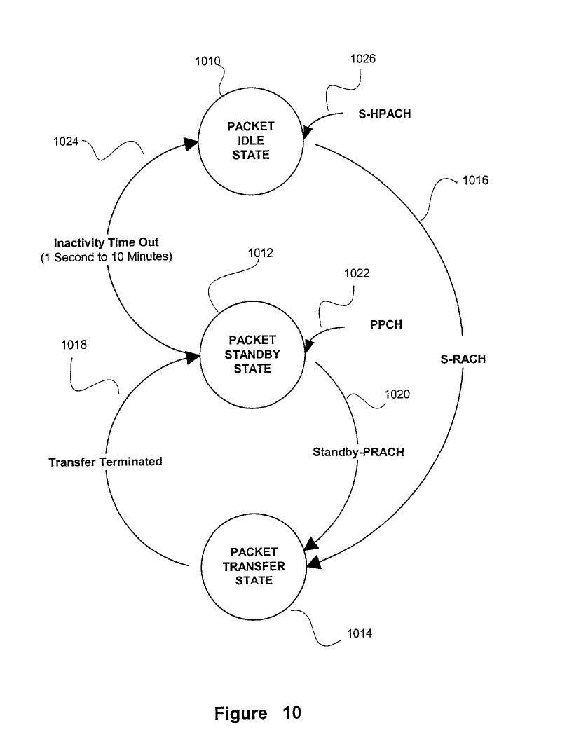

FIG. 10 is a state diagram illustrating states of operation in accordance with an aspect of the invention. In FIG. 10, the idle state is represented by state 1010, and somewhat corresponds to the GPRS idle state, in that no data is being transferred between the user terminal and the gateway or cell base station. In the idle state 1010, the synchronization is one-way, in that the user terminal is locked to signals produced by the NCC or cell base station. In both cases, the user terminal is “listening” to the circuit-switched rather than packet-switched channels. In FIG. 10, the data active transfer state is designated as 1014, and somewhat corresponds to the active packet transfer state of the GPRS system. The transition from the idle state 1010 to the active state 1014 is performed in the fashion described in FIG. 9 for transfer from state 906 to the state represented by block 934. In accordance with an aspect of the invention, once actual packet data transfer is ended, the active transfer state 1014 of FIG. 10 makes a transition 1018 to the standby state of operation designated 1012. This standby state has no equivalent state in the GPRS standard. In the standby state 1012, the user terminal is “listening” to the packet data channels from the gateway. More particularly, the user terminal acts on newly defined signals, namely Standby-PCCCH and Standby-PTCCH, which are transmitted by the gateway. These signals allow the user terminal to remain in nominal synchronization with the gateway, where the term nominal means something less than full synchronization as required for packet transfer over the PDTCH channel.

In FIG. 10, the logic leaves standby state 1012 and flows to active transfer state 1014 in response to receipt of an additional data packet. Such an additional data packet may be a data packet received by the user terminal for transmission to the gateway, corresponding to transition path 1020, or it may be a signal, represented by 1022, from the gateway that an additional data packet is available for transmission. This signal is transmitted on the packet paging channel PPCH. During normal operation, the user terminal (or of the corresponding channel of the gateway) may repeatedly transfer between the standby and active transfer operating states. Eventually, the data packet transfer will actually end because the user stops sending data, and the standby state of operation makes a transition along transition path 1024 back to the idle state. Transition path 1024 occurs in response to the predetermined time lapse without arrival of a data packet for transmission. This time interval may range from about a second to about ten minutes, and is remotely reconfigurable.

FIG. 11 represents the transition between standby state 1012 of FIG. 10 to the active packet transfer state 1014. In FIG. 11, the transition from standby state 1012 includes the transmission 1110 by the user terminal of a packet channel request to the gateway for packet channel resources by way of a new signal, designated standby packet random access channel (Standby-PRACH). This signal is transmitted by way of arrow 1110 to the satellite, and by way of arrow 1112 from the satellite to the relevant gateway. The gateway processes the request, and assigns packet resources (if available). The frequency is already synchronized, but there may be a time offset between the user terminal and the gateway, and the packet uplink assignment response made to the user terminal by the gateway (arrows 1114 and 1116) includes allocation of a slot and frequency, and also an update on the timing. The packet uplink assignment is sent over PAGCH. The communications represented by FIG. 11 prior to the packet transfer state involve twelve one-way propagation's to and from the satellite, corresponding to about one and one half second, by comparison with the FIG. 11 which involves eight one-way propagations to and from the satellite, corresponding to about one second.

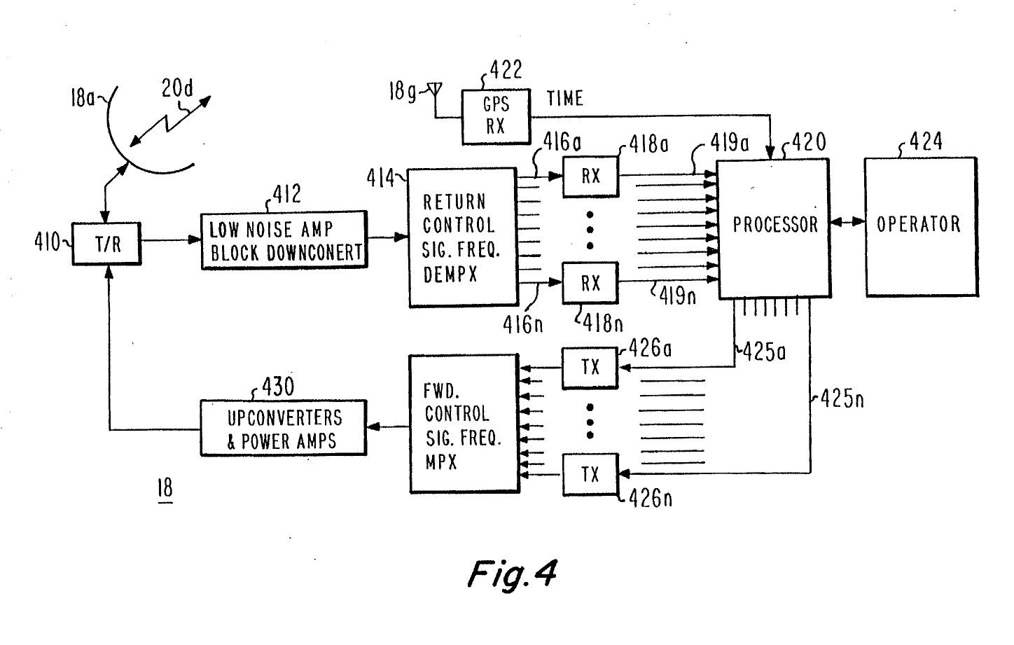

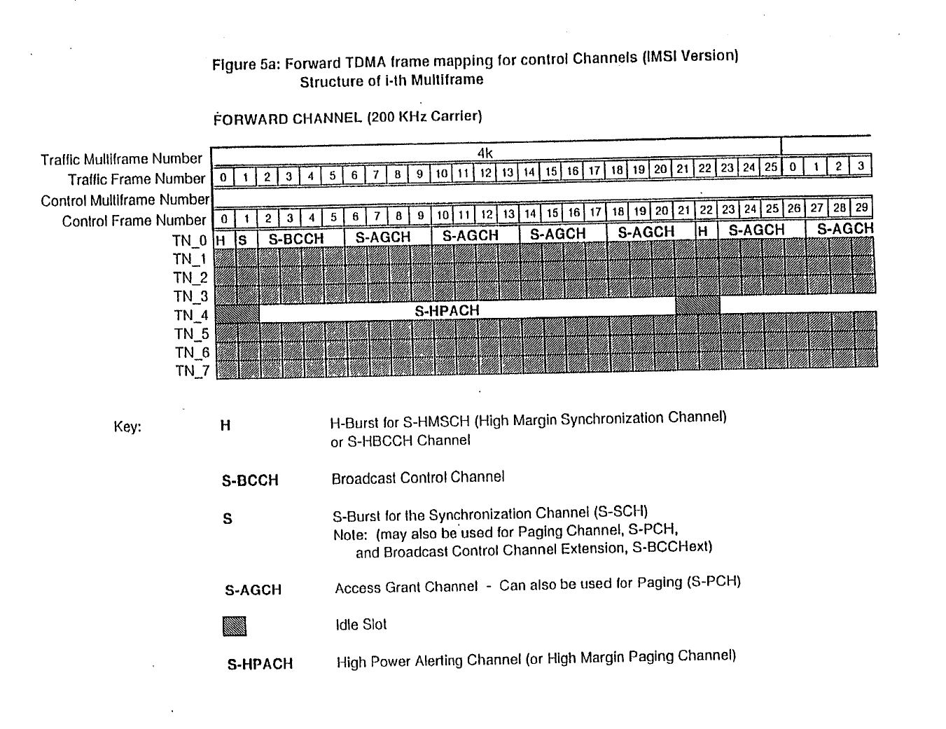

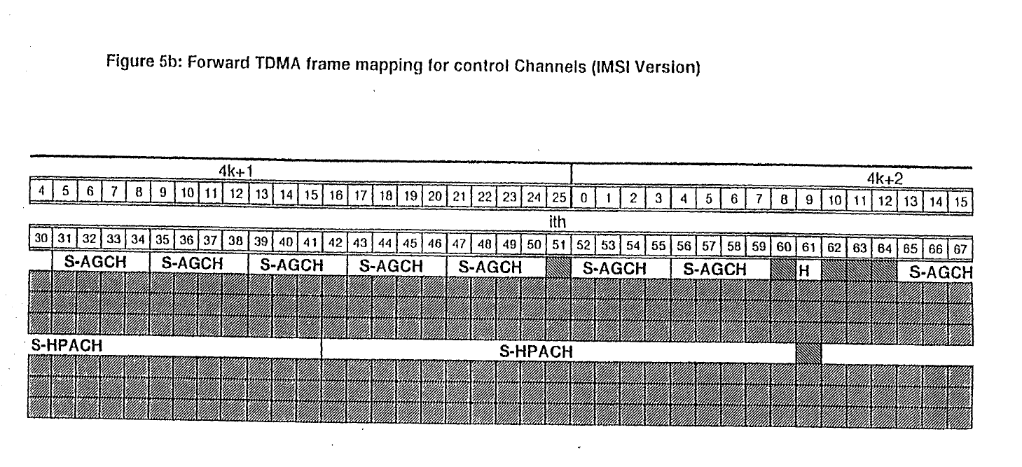

In comparing FIG. 11 with FIG. 9, it may be seen that signals 914, 916, 917 and 918 of FIG. 9 are not used or required when transitioning from the standby state 1012 of FIG. 10 to the active transfer state 1014. This represents a time saving of at least 0.5 seconds, assuming the propagation delay to the satellite is 0.125 seconds, over the setup time for the transition from the idle state to the transfer state as illustrated by FIG. 9. In addition to a time savings with regard to the propagation delays to and from the satellite, the standby state eliminates the involvement of the NCC, for the time and frequency processing on the S-RACH channel and for the processing of the immediate assignment message on the S-AGCH channel, such that the resources of the NCC can be better utilized for the circuit switched services as abovedescribed for FIG. 4. The timing and frequency synchronization processing has been reduced to a relatively simple time and frequency synchronization step at the gateway before transitioning to the transfer state. The gateway provides the timing advance value to the user terminal as part of the packet assignment message to satisfy the fine timing synchronization required for the packet transfer state. Over the course of a large data transfer, made up of multiple packets, this time saving translates into increased throughput.

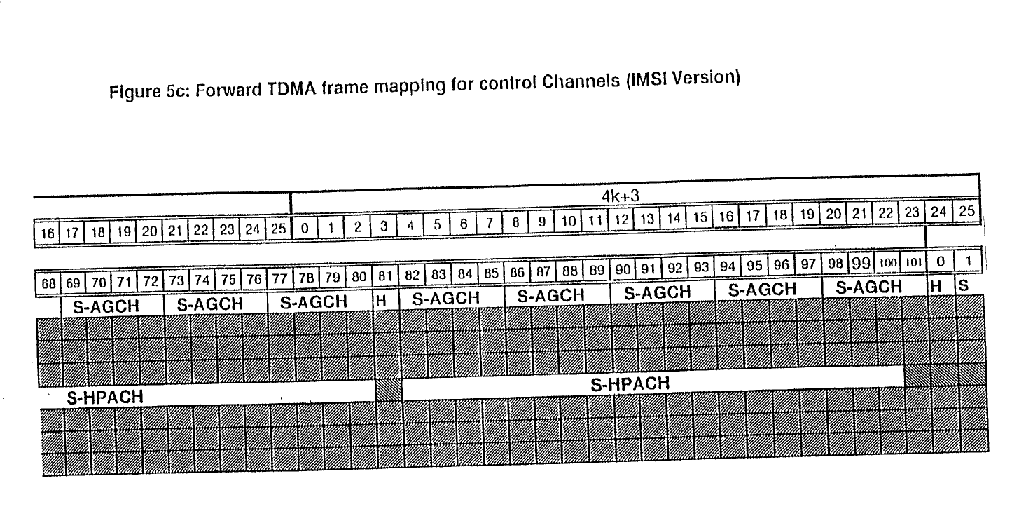

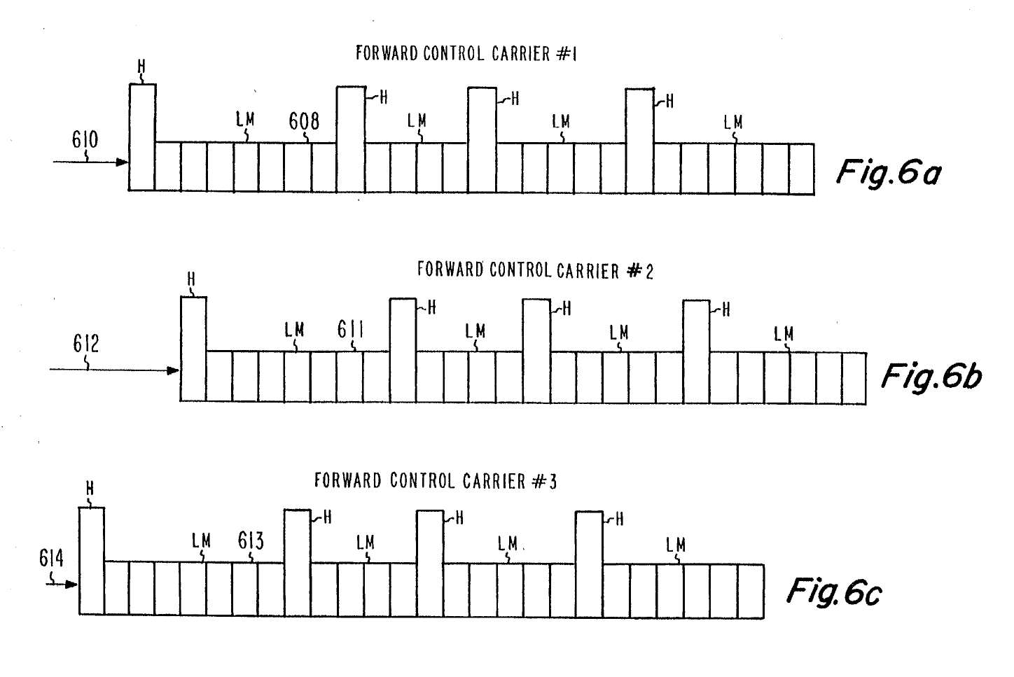

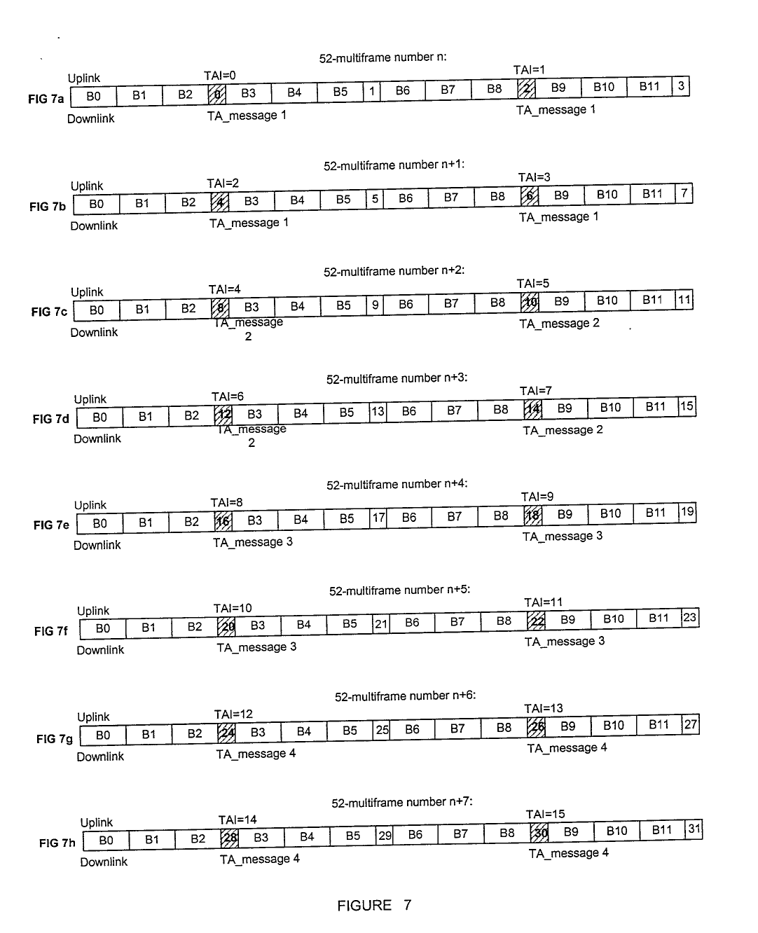

The standby-PTCCH utilizes the idle time slots shown in FIG. 7 which illustrated the PTCCH mapping to the GPRS multiframe format.

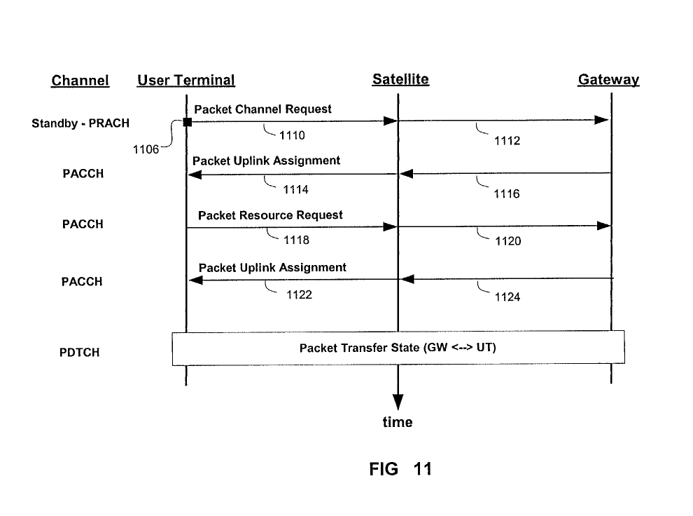

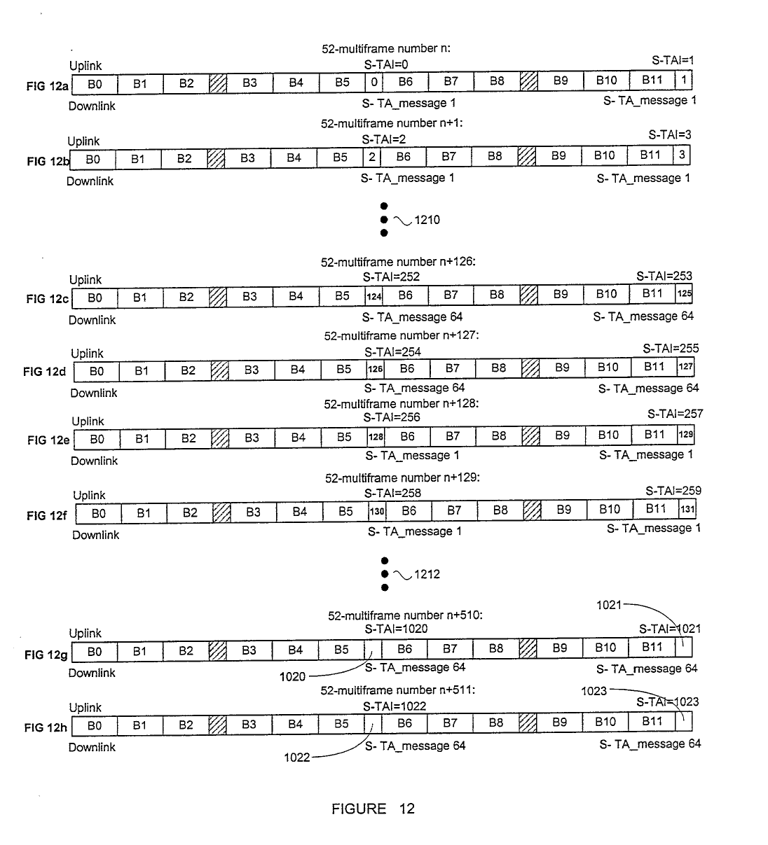

FIGS. 12a, 12b, 12c, 12d, 12e, 12f, 12g, and 12h, together constitute a potential mapping of uplink standby access bursts and downlink standby timing advance (S-TA) messages onto groups of 512 52-multiframes, according to a further aspect of the invention. More particularly, FIG. 12a is for 52-multiframe n, FIG. 12b is for 52-multiframe n+1, FIG. 12c is for 52-multiframe n+62, FIG. 12d is for 52-multiframe n+63, FIG. 12e is for 52-multiframe n+64, FIG. 12f is for 53-multiframe n+65, FIG. 12g is for 53-multiframe n+510, and FIG. 12h is for 52-multiframe n+511. The grouping of the 512 multiframes defines one complete cycle for the standby-PTCCH procedure. In this embodiment or implementation, up to 1024 user terminals can be maintained in the standby state. A comparison of FIG. 12 with FIG. 7 shows that the standby-PTCCH channel utilizes the idle time slots of the PTCCH format defined in FIG. 7. The PTCCH channel, represented by the cross-hatched time slots in FIG. 12, can continue to be applied to user terminals in the MAC transfer state i.e. the standby packet data channel (standby-PDCH) consisting of standby packet common control channel (Standby-PCCCH), packet data transfer channel (PDTCH), packet associated control channel (PACCH), packet data transfer channel (PDTCH), packet timing control channel (PTCCH), and standby packet timing control channel (standby-PTCCH) for which the MAC can multiplex user terminals in the transfer state onto the PDTCH and PTCCH channels. That is to say, user terminals in the standby state and user terminals in the transfer state share the resources of the standby packet data channel under control of the MAC protocol.

Within each mapping or timing diagram of FIGS. 12a, 12b, 12c, 12d, 12e, 12f, 12g, and 12h, radio blocks designated as B0 through B11 represent four time slots of data transfer between a user terminal and a gateway. The last or rightmost time block of FIGS. 12a, 12c, 12d, 12e and 12g temporally adjoins the first time block of the next multiframe as described for FIG. 7. The ellipses consisting of three dots 1210 represent a gap in time, consisting of 60 multiframes, between the multiframe of FIG. 12b and the multiframe of FIG. 12c. Likewise, the ellipses 1212 represent a gap in time, consisting of 444 multiframes, between the multiframe of FIG. 12f and the multiframe of FIG. 12g.

In each mapping of FIGS. 12a, 12b, 12c, 12d, 12e, 12f, 12g, and 12h, the cross-hatched separator time slots represent the time slots used by the PTCCH channel for channels in the transfer state. The separator time slots numbered from 0, in FIG. 12a, to 1023, in FIG. 12h, represent the mapping of the standby-PTCCH time slots. In the uplink direction, which is to say from the user terminal to the gateway, the user terminals transmit standby access bursts at the predefined time slot indicated by the standby timing advance index (S-TAI) number. As a user terminal enters the standby state, it is assigned a unique standby timing advance index number from 0 to 1023. At the designated time slot, the user terminal transmits the standby access burst to the gateway. The gateway measures the time offset, with respect to a known time reference, and stores the time offset as a timing advance command value for future transmission to the user terminal via the timing advance messages.

In the downlink direction of FIGS. 12a through 12h, the various gateways to which the user terminals are assigned transmit their timing advance information, each to its “own” user terminals. Each group of four timing advance slots in the downlink direction can be viewed as a four-slot “radio” block distributed in time. Each group of four timing advance slots, as for example slots designated 0, 1, 2, and 3 of FIGS. 12a and 12b, carries the first standby timing advance message (S-TA_message 1) for the represented standby timing advance cycle. Each standby timing advance message provides the timing advance command for 16 user terminals. S-TA_message 1 will provide the timing advance commands for user terminals corresponding to the assigned standby timing advance index numbers 0 through 15. S-TA message 2, not represented in FIG. 12, sends the timing advance commands to user terminals corresponding to the assigned standby timing advance index numbers 16 through 31. This process continues up to S-TA message 64, whose four-slot “radio” block is made up of time slots 124, 125, 126 and 127 of FIGS. 12c and 12d. It takes 64 S-TA messages to provide 1024 user terminals with their timing advance commands.

FIG. 12 maintains synchronization of up to 1024 user terminals. Each user terminal of the group of 1024 user terminals with a standby timing advance message receives a timing advance command every 128 multiframes in the embodiment represented by FIG. 12. Therefore, each user terminal in the standby state receives four standby timing advance commands over the 512 multiframe standby timing advance cycle. Each user terminal in the standby state issues a standby access burst once every 122.88 seconds (512 multiframes at 240 msec). The gateway measures the timing offset with respect to a reference time and issues the timing advance commands as described above.

The standby-PTCCH access burst and the standby-PRACH access burst must accommodate the amount of timing drift over the 122.88 seconds during which the user terminal is not in contact with the gateway. Assuming a worst-rate drift rate of 1.7×E-7 seconds per second for a satellite based mobile cellular communication system like AceS, including both drift associated with the satellite movement and with user terminal movement, the total drift over the 122.88 second interval is 20.8896 micro seconds. Therefore, the access burst designed for both the standby-PTCCH channel and the standby-PRACH channel should provide guard time to account for the 20.8896 microseconds of timing offset.

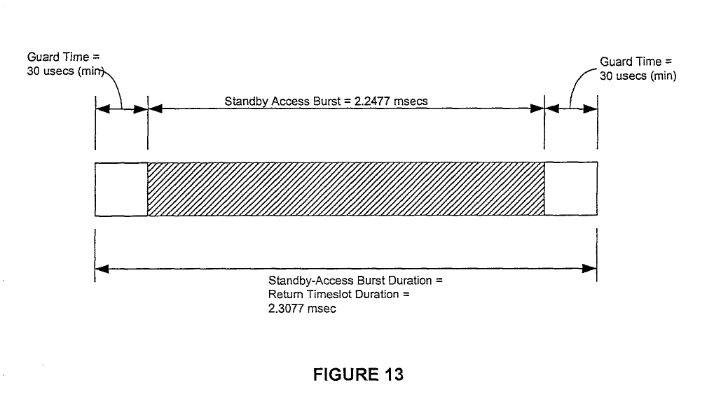

FIG. 13 illustrates the requirements for an access burst which provides a minimum of 30 microseconds guard time to prevent overlap with time slots of adjacent radio blocks. The GPRS standard access burst, defined in GSM document 05.02, is compatible with the requirements of FIG. 13.

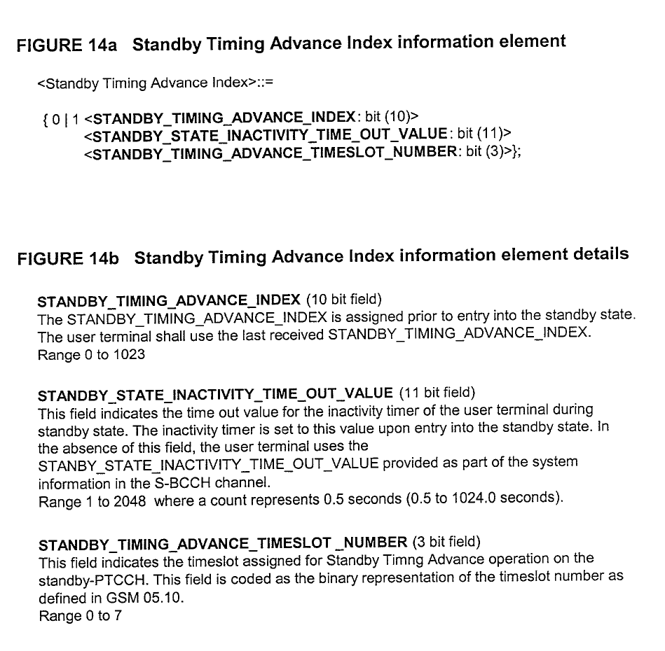

FIG. 14 defines a potential Standby Timing Advance Index information element which is added to the Uplink Packet Channel Assignment message andor the Downlink Packet Channel Assignment message provided by the gateway to the user terminal over the PACCH channel to assign the standby timing advance index, a 10 bit value representing an index number from 0 to 1023, as abovedescribed in FIG. 12. The user terminal remembers the standby timing advance index value for use when the user terminal transitions into the standby state. The user terminal, when in the standby state, uses the last received standby timing advance index value. The Standby Timing Advance Index information element also provides the user terminal with the inactivity timer value for use in the standby state as abovedescribed.

The above description presupposes that the network control center and the gateway are at separate geographic locations, thereby requiring that communications between the network control center and the gateway be routed via the satellite. The abovedescribed invention can be equally applied to a wireless TDMA communications system where the network control center and the gateway are co-located. Communication signals 914, 916, 917 and 918 of FIG. 11 are eliminated in such an embodiment. Therefore, the effective time savings of one half second between the timing sequence of FIG. 11 with respect to FIG. 9 would not be realized. However, the incorporation of the standby state, and more particular the ability of the network and user terminal to stay in time and frequency synchronization, provides processing and resource savings over a system which does not implement the standby state. The standby state allows the system to use the standby-PRACH, a random access channel that is multiplexed onto the same TDMA time slots as the packet data transfer channel and requires minimal processing for time synchronization, instead of the RACH channel which uses a dedicated carrier and requires special processing for time synchronization. The RACH requires use of a separate return carrier due to the large difference in the propagation path times between a user terminal and the network for different locations of the user terminal in the spotbeam or cell where the maximum difference in the propagation path times is significantly larger than the TDMA slot time. In fact, the abovedescribed invention can be applied to a mobile wireless TDMA communications system that does not utilize a satellite, but services user terminals where the cell size is large with respect to the propagation path times between the network and the user terminal i.e. there is a large difference in the propagation path times between a user terminal and the network for different locations of the user terminal in the cell where the maximum difference in the propagation path times is significantly larger than the TDMA slot time.

1. A method for operating a user terminal of a wireless TDMA packet data communication system including a network communication center and a plurality of gateways, said method comprising the steps of:
at said user terminal, operating in an idle state in which said user terminal is attached to a network so that the network is aware of the presence of the user terminal, but said user terminal is not in communication with a gateway;
at said user terminal, transitioning from said idle state to an active state in response to one of (a) said network and (b) said user terminal generating a signal indicating that data is to be transmitted, by use of common control channels of said data communication system, by transitioning control to one of said gateways;
in said active state of said user terminal, transferring said data between said user terminal and said gateway;
immediately following said transferring of said data, transitioning from said active state to a standby state, in which timing information, but not data, is exchanged between said user terminal and said gateway;
in response to generation of a further signal indicating that data is to be transmitted by (a) said user terminal and (b) said gateway, transitioning said user terminal from said standby state of operation to said active state of operation; and
in response to expiration of a preset period of time in which no signal indicating that data is to be transmitted is generated, transitioning said user terminal from said standby state to said idle state.

2. A method for operating a user terminal of a wireless TDMA packet data communication system, which communication system includes a plurality of user terminals and a network, in which the said user terminal can be in one of an idle state, a stand-by state and an active state, wherein:
said idle state is a state in which said user terminal is attached to a network in a communication sense so that the network is aware of the presence of said user terminal, but said user terminal is not in communication with said network;
said active state is a state in which said user terminal transfers data between said user terminal and said network; and
said standby state is a state in which timing information, but not user data, is exchanged between said user terminal and said network.

3. A method according to claim 2, wherein, in said standby state, said network sends timing adjustment messages to said user terminal.

4. A method for operating a user terminal of a wireless TDMA packet data communication system, said communication system including a plurality of user terminals and a network, in which the said user terminal is capable of being in one an idle state, an active state, and a standby state, and in which said user terminal transitions from said idle state to said active state in response to one of (a) said network and (b) said user terminal generating a signal indicating that data is to be transmitted, said transition being by use of common control channels of said data communication system.

5. A method for operating a user terminal of a wireless TDMA packet data communication system, said data communication system including a plurality of user terminals and a network, in which each said user terminal is capable of being in one an idle state, an active state, and a standby state, and in which each said user terminal transitions from said active state to said standby state immediately following data transfer, and in which timing information, but not data, is exchanged between said user terminal and said network in said standby state.

6. A method for operating a user terminal of a wireless TDMA packet data communication system including a plurality of user terminals and a network, in which each said user terminal is capable of being in one of an idle state, an active state, and a standby state, and in which each said user terminal transitions from said standby state to said active state in response to generation of a further signal indicating that data is to be transmitted by (a) said user terminal and (b) said network.

7. A method for operating a user terminal of a wireless TDMA packet data communication system, said communication system including a plurality of user terminals and a network, in which each said user terminal is capable of being in an idle state, an active state, and a standby state, and in which each said user terminal transitions from its standby state to its idle state in response to expiration of a preset period of time in which no signal indicating that data is to be transmitted is generated by said network and that one of said user terminals.

8. A method for operating a user terminal of a wireless TDMA packet data communication system, said communication system including a plurality of user terminals and a network, in which each said user terminal can be in one of an idle state, a stand-by state, and an active state, and where said network includes a Network Control Center, a plurality of Gateways, and one or more satellites which provide communication between the user terminals and said NCC and at least some of said Gateways.
